(19) United States
(12) Patent Application Publication
(10) Pub. No.: US 2006/0182948 A1
(43) Pub. Date: Aug. 17, 2006

(54) Resin-coated metal sheet

(75) Inventors: Takeshi Watase, Hyogo (JP); Yasuo Hirano, Hyogo (JP); Takuya Kusaka, Hyogo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Kobe Seiko Sho, Kobe-shi, Hyogo (JP)

(21) Appl. No.: 10/563,305

(22) PCT Filed: Jul. 5, 2004
(86) PCT No.: PCT/JP04/09872

§ 371 Date: Jan. 4, 2006

(30) Foreign Application Priority Data
Jul. 7, 2003 (JP) 2003-271501
Feb. 27, 2004 (JP) 2004-054800

(51) Int. Cl. B32B 15/08; B32B 15/09; B32B 27/20

(52) U.S. Cl. 428/323; 428/457; 428/458; 428/339

(57) ABSTRACT

Disclosed is a resin coated metal sheet for use in electronic equipment components which can provide excellent microwave absorbability and workability by coating a magnetic coating film containing from 20 to 60 mass % of a magnetic powder at a thickness of 3 to 50 μm on at least one surface of a metal sheet and, optionally, also has a favorable heat releasing property; a heat releasing property and a self-cooling property; scratch resistance and fingerprint resistance; and electrical conductivity, and which is particularly useful as a constituent material as a casing for electronic equipment.

### TECHNICAL FIELD

The present invention concerns a resin coated metal sheet of excellent microwave absorbability and workability which is useful as a constituent material, for example, of casings, particularly, in electronic, electric and optical equipment (hereinafter sometimes represented typically by electronic equipment) and, more in particular, it relates to a resin coated metal sheet improved with characteristics such as heat releasing property; heat releasing property and self-cooling property; scratch resistance and fingerprint resistance; electrical conductivity, etc.

### BACKGROUND ART

As electronic equipment has been improved for the performance and reduced in the size in recent years, performance of not leaking microwaves generated from electronic equipment to the outside (microwave shielding property) has been demanded and it is an important subject for electronic equipment designers how to realize such performance. When leakage of microwaves from electronic equipment increases, this may possibly result in erroneous operations of precision instruments, etc. located at the vicinity of the electronic equipment. With the viewpoint as such, leakage of microwaves in a wavelength region from 30 MHz to 1 GHz has been regulated in VCCI standards operated as voluntary regulation standards in Japan for regulating undesired radiation levels from electronic equipment.

On the other hand, good heat releasing property is also required for electronic equipment and in order to improve the heat releasing property, a structure having vent holes in the casing of the electronic equipment is effective (as described specifically later). However, such a structure is not preferable with a view point of the microwave shielding property, and the presence of the vent holes rather form a place where microwaves tend to leak. That is, in the casing for the electronic equipment, a structure for improving the heat releasing performance provides a negative factor in view of the microwave shielding property, and the heat releasing property and the microwave shielding property conflict against each other with the structural point of view.

As described above, since the structure for the electronic equipment undergoes restriction described above, it has been proposed a technique of improving the microwave shielding property in another aspect. For example, materials of excellent electrical conductivity such as galvanized steel sheets have been used as materials for the casings of the electronic equipment while taking notice on that “microwaves leak not only through vent holes or wiring holes but also leak through gaps between steel sheets” and with a view point that “leakage of microwaves can be decreased by using a steel sheet of excellent electrical conductivity since this can decrease the gap between the steel sheets to each other”. However, this method can decrease only the microwaves leaked through the gap between the steel sheets and cannot prevent leakage of microwaves through the vent holes or wiring holes, failing to obtain good microwave shielding property.

On the other hand, it has also been proposed a technique of appending sheets or tapes having microwave absorbability to microwave generation sources or gaps in a casing thereby decreasing leakage of microwaves. For example, JP-A No. 2000-200990 proposes a microwave absorbent in which a soft magnetic powder comprising a Fe-based alloy containing about 5 to 35% of Cr is dispersed in rubber or resin. Further, JP-A No. 2002-111276 proposes a microwave absorbent in which a soft magnetic metal powder is dispersed in an insulative sheet comprising a thermosetting resin. The techniques described above are excellent with a viewpoint of the microwave absorbability.

However, in the two documents described above, it is necessary to incorporate a substantially great amount of magnetic powder (10% by volume or more) in a resin with an aim of attaining the microwave absorbability, which increases the film thickness (for example, 1 mm or more) and makes it difficult for press work, so that they involve a problem that they are applicable only to restricted portions such as on the surface of microwave generation sources or for the gaps in the electronic equipment.

On the other hand, JP-A No. 2001-274587 proposes a microwave absorbent by stacking a microwave absorption layer formed by mixing and dispersing a stainless steel flake in a substrate comprising a synthetic resin material on a microwave reflection layer comprising a metal. The technique has been proposed for attaining absorption of higher frequency (1 GHz or higher) microwaves, it is also necessary to incorporate a substantially great amount of the magnetic powder in the microwave absorption layer like each of the documents described above, and the thickness is increased (to about 1.5 to 3.5 mm) to result in a problem in view of workability and it is difficult to be applied as a constituent material for use in the casing of the electronic equipment requiring severe processing such as bending.

On other hand, along with recent improvement for the performance and reduction in the size of electronic equipment, the amount of heat generated inside of chassis for electronic equipment, etc. increases (temperature increase) to result in a problem of increasing the temperature (temperature increase in electronic equipment). The internal temperature of the electronic equipment sometimes reaches a high temperature of about 40 to 70° C. and about 100° C. at the highest under usual atmospheric temperature. Then, since this exceeds the heat resistant temperature of IC or CPU (semiconductor device), disk, motor, etc. it has been considered that this may give a trouble on stable operation. When temperature increases further, this destroys the semiconductor devices to cause failure thereby resulting in a problem of lowering the life of electronic equipment parts.

It has therefore been keenly demanded for the provision of a novel casing for electronic equipment parts (casing main body, frame, shielding case, back panel for liquid crystal display, etc.) capable of lowering the internal temperature of electronic equipment (heat releasing property) while satisfying the primary property required for the electronic equipment (ensuring air tightness or water proofness and dust proofness, and reduction in the size and the weight).

As a surface treating material used for such application, JP-A No. 2002-228058 discloses a heat releasing surface treating material having a top layer coating film and a bottom layer coating film on the surface of a substrate with the emissivity of the bottom layer coating film being 70% or more; JP-A No. 2002-226783 discloses a heat radiating surface treating material having at least one layer of coating film on the surface of a substrate with the emissivity as the surface treating material being 60% or more respectively. Any of the documents is in common with the present invention with respect to objects to be applied (application use) since the material is used for application such as casings (box-like outer body) or heat releasing sheets for home electronic products generating heat in the inside but they are different from the present invention in view of the fundamental idea of improving the heat releasing property, and specific means used therefor are also different.

That is, any of the documents described above provides a surface treating material having high emissivity at the surface with the concept that “heat radiating property of the heat releasing sheet (surface) has to be improved for propagating heat generated from the inside in the route of heat source→heat conduction device→heat releasing sheet, and rapidly radiating the heat from the heat releasing sheet”, but emissivity at the rearface of the surface treating material has not been taken into consideration at all. In other words, the idea in the documents described above “intends for bringing the heat source (heat generation body) inside an electronic equipment into contact with a surface treating material, absorbing the amount of heat emitted from the heat source by way of heat conduction to the surface treating material (at the rearface thereof) and then dissipating the same by heat radiation (from the surface of the surface treating material) (heat conduction→radiation)”. This is different from the basic idea of the present invention of “absorbing heat emitted from the heat source (heat generation body) inside the electronic equipment (radiation heat) by the heat releasing coating film at the rearface (radiation) and radiating the heat from the coating film at the surface (radiation→radiation)” (to be described later). Actually, since only the means of increasing the surface emissivity is disclosed for the surface treating material of the documents and it does not intend to increase the absorption rate at the rearface, the rearface is left uncoated (with no coating film) and the constitution as in the present invention of applying a heat releasing coating film to the rearface, or ensuring a predetermined absorption rate by forming a coated film on the rearface is not disclosed at all.

In addition, JP-A No. 3-120378 discloses a method of manufacturing a far-infrared radiation sheet to be used for thermal equipment parts (substrate formed with a ceramic layer having far-infrared characteristics). However, the far-infrared radiation sheet of JP-A No. 2001-274587 is used in the field of thermal equipment (typically, stove or the like) requiring heat radiating property at an extremely high temperature of about 200 to 300° C., and it does not intend at all particularly for the application use to electronic equipment materials in which the internal temperature is about 40 to 70° C. and about at 100° C. at the highest as in the coated material of the invention. Accordingly, inventions for both of them are different from each other in view of the object to be applied (application use). Further, the documents do not disclose at all for the technical idea inherent to the present invention that the heat emitted from the electronic equipment is absorbed to “rearface of the substrate” and is radiated from “surface of substrate”.

In addition to the heat releasing property described above, the casing for the electronic equipment is also required to have a function of suppressing the temperature increase in the casing itself, because this can prevent the risk that a user should be in contact with the casing and suffers from burning during operation of the electronic equipment and can provide safe products. “The property of suppressing the temperature elevation in the casing itself of electronic equipment” is particularly referred to as “self-cooling property” in the invention with an aim of distinguishing from the “heat releasing property” described above. For obtaining a casing excellent in both of the properties, use of the countermeasure for heat releasing as described above (method of attaching heat releasing parts such as a heat sink or heat pipe or method of aperturing a metal sheet and attaching blower, etc.) may also result in similar problems. Accordingly, it has also been demanded keenly to provide a case having both of the properties.

Further, the casing for electronic equipment are also required to be excellent in view of electrical conductivity in addition to the properties described above. However, black coated steel sheets (steel sheets coated with black coating layer) used so far involve a problem that the electrical resistance increases since the thickness of the black coating film is excessively large and, particularly, no effective grounding to the earth can be taken for application use to electronic equipment.

Further, scratch resistance is also required to the casing for electronic equipment. For example, black metal sheets involve a problem that they are liable to suffer from scratches during handling or processing (reduced ability of scratch resistance) and that fingerprints, if left, tend to become conspicuous (reduced ability of fingerprint resistance).

Among them, for the improvement of “scratch resistance”, countermeasures such as increase of the film hardness or improvement for the film lubricity by adding waxes in the film have been applied. However, the effect for the improvement by the methods described above undergoes restriction and involves drawbacks, for example, that the film hardness or lubricity cannot be increased by so much in a case where severe processing is required such as bending of the black metal sheet.

In view of the above, JP-A No. 2001-18322 discloses a conductive surface treated black metal sheet coated with a transparent coating film to a black coating film as a metal sheet capable of solving the problems altogether. This has been filed based on knowledge that “transparent coating film is effective to the provision of electrical conductivity and, at the same time, has an effect of remarkably improving the scratch resistance and fingerprint resistance”, which is applicable also to such application use as requiring bending processing. However, in the subsequent study, it has been found that while the transparent coating film can improve scratches of the film it is still difficult to suppress scratches themselves that are generated, for example, by the edges of steel sheets. Further, since the metal sheet coated with the transparent coating film reflects the tone of the black coating film as it is to the appearance, scratches or fingerprints tend to become conspicuous depending on the color and the improving effect due to the formation of the transparent coating film cannot sometimes be developed effectively.

In view of the above, the present inventors have noted and studied on white pigment and/or luster pigment in order to provide a novel coating film capable of solving the subject described above instead of the transparent coating film.

The pigment described above is known per se and the white pigment includes titanium oxide and the like and the luster pigment (metallic pigment) includes pearl pigment and aluminum pigment, etc., typically. Since such pigments exhibit glitter color, metallic color or pearlescent color due to reflected light and provide versatile and esthetically excellent appearance, they have been used for various application uses such as in automobiles, various kinds of printed matters and OA equipment but the idea of using the pigments with an aim of improving the scratch resistance or fingerprint resistance has not been present at all.

For example, JP-A Nos. 2002-363771, 10-330657 and 2002-12795 disclose various luster pigments/metallic pigments/modified pearlescent pigments, but they were proposed only for the primary purpose of improving the characteristics (glitter feeling, amount of reflection light) of the pigments and they teach nothing as to what effect can be provided by the pigments in relation with the scratch resistance and the fingerprint resistance, or what control can provide the scratch resistance of the resin coating film containing the pigment described above.

The present invention has been accomplished under the foregoing situations and it intends to provide a resin coated metal sheet for electronic equipment components which can provide excellent microwave absorbability and workability, and optionally has a favorable heat releasing property; a heat releasing property and a self-cooling property; scratch resistance and fingerprint resistance; and electrical conductivity, and which is particularly useful as a constituent material as a casing for electronic equipment.

### DISCLOSURE OF THE INVENTION

The resin coated metal sheet according to the present invention capable of obtaining the subject described above has a feature in including the following embodiments (I) to (VI).

(I) Resin Coated Metal Sheet with Excellent Microwave Absorbability and Workability (Hereinafter Sometimes Referred to as a First Coated Material)

This is a coated sheet in which a magnetic coating film containing 20 to 60% of a magnetic powder (“%” means herein “mass %” unless otherwise specified) is coated on at least one surface of a steel sheet to a thickness of 3 to 50 μm.

The magnetic powder used in the invention can include soft magnetic ferrite and magnetic metal powder which corresponds in each of the cases to about 10% by volume on the volume basis. Further, the resin constituting the magnetic coating film is preferably a polyester type resin.

In the coated metal sheet according to the invention, an electrically conductive additive can be added further by about 20 to 40% in the magnetic coating film to provide the magnetic coating film with electrical conductivity. In this case, the film thickness is preferably from 3 to 15 μm for maintaining good electrical conductivity. Further, when the electrically conductive additive is added, the total content of the electrically conductive additive and the magnetic powder is preferably from 30 to 60%.

(II) Resin Coated Metal Sheet Excellent in Microwave Absorption Property, Workability and Heat Releasing Property (Hereinafter Sometimes Referred to as a Second Coating Material)

This is a coated sheet satisfying the following (II-1) or (II-2) and also satisfying the following (II-3) in the first coated sheet.

(II-1) A heat releasing magnetic coating film which is a magnetic coating film and has a heat releasing property is coated on one surface of the metal sheet, and a heat releasing coating film of 1 μm or more is coated on another surface of the metal sheet,

(II-1-i) at least one of the heat releasing magnetic coating film and the heat releasing coating film contains 1% or more of carbon black, and

the surface not containing carbon black contains 10% or more of a heat releasing additive other than carbon black; or

(II-1-ii) at least one of the heat releasing magnetic coating film and the heat releasing coating film contains 30% or more of titanium oxide, and

the surface not containing titanium oxide contains 1% or more of a heat releasing additive other than titanium oxide.

(II-2) A heat releasing magnetic coating film which is a magnetic coating film and has a heat releasing property is coated on both surfaces of the metal sheet, a heat releasing magnetic coating film which is a magnetic coating film and has a heat releasing property is coated on one surface of the metal sheet and a heat releasing coating film of 1 μm or more is coated on the other surface of the metal sheet,

(II-2-i) At least one of the heat releasing magnetic coating films contain 1% or more of carbon black (preferred average particle size: 5 to 100 nm),

the surface not containing carbon black contains 10% or more of the heat releasing additives other than carbon black, or

(II-2-ii) at least one of the heat releasing magnetic coating films contains 30% or more of titanium oxide and the surface not containing titanium oxide contains 1% or more of heat releasing additives other than titanium oxide.

(II-3) The integrated emissivity of infrared rays (wavelength: 4.5 to 15.4 μm) when the resin coated metal material is heated to 100° C. satisfies the following formula (1).
a×b≧0.42 formula (1)

a: integrated infrared emissivity on one surface of a resin coated metal sheet,

b: integrated infrared emissivity on the other surface of a resin coated metal sheet.

(III) Resin Coated Metal Sheet of Excellent Microwave Absorbability, Workability, Heat Releasing Property and Self-Cooling Property (Hereinafter Sometimes Referred to as a Third Coated Material)

This is a coated sheet satisfying the following (III-1) or (III-2) and also satisfying the following (III-3) in the first coated material.

(III-1) The magnetic coating film is coated on a first surface of a metal sheet and a heat releasing coating film is coated to 1 μm or more on a second surface on the side opposite to the first surface,

the heat releasing coating film contains 1% or more of heat releasing additives and

the magnetic coating film selectively contains further 1% or more of heat releasing additives.

(III-2) The magnetic coating film is coated on both surfaces of a metal sheet,

the magnetic coating film on the first surface of the metal sheet selectively contains 1% or more of heat releasing additives and

the magnetic coating film on the second surface on the side opposite to the first surface contains 1% or more of heat releasing additives.

(III-3) The integrated emissivity of infrared rays (wavelength: 4.5 to 15.4 μm) when the resin coated metal material is heated to 100° C. satisfies the following formula (2) and the following formula (3).
b≦0.9(a−0.05) formula (2)
(a−0.05)×(b−0.05)≧0.08 formula (3)

a: integrated infrared emissivity on the second surface of the resin coated metal sheet.

b: integrated infrared emissivity on the first surface of the resin coated metal sheet.

(IV) Resin Coated Metal Sheet of Excellent Microwave Absorbability, Workability, Scratch Resistance and Fingerprint Resistance (Hereinafter Sometimes Referred to as a Fourth Coated Material)

This is a coated sheet satisfying the following (IV-1) or (IV-2) and also satisfying the following (IV-3) and (IV-4) in the first coated material.

(IV-1) The magnetic coating film is coated on one surface of the metal sheet, the magnetic coating film selectively contains black additives, the magnetic coating film containing the black additives is selectively coated with a resin coating film containing at least one of a white pigment and a luster pigment, and

a black coating film containing black additives and a resin coating film containing at least one of a white pigment and a luster pigment are coated on the other surface of the metal sheet.

(IV-2) The magnetic coating film is coated on both surfaces of the metal sheet,

the magnetic coating film at least on one surface is a black magnetic coating film containing black additives, a resin coating film containing at least one of a white pigment and a luster pigment is coated on the black magnetic coating film,

a resin coating film containing at least one of a white pigment and a luster pigment is selectively coated on the other surface.

(IV-3) Each of the film thickness of the resin coated films is 0.5 to 10 μm and the addition amount of the white pigment and the luster pigment contained in the resin coating film is 1 to 25% in total.

(IV-4) The color of the resin coated metal sheet containing at least one of the white pigment and the luster pigment satisfies the L value from 44.0 to 60.0 as measured by a color difference meter (SZS-Σ90) manufactured by Nippon Denshoku Industries Co., Ltd.

Further, for the white pigment or the luster pigment, oxide series pigments are preferred and, among all, those containing titanium oxide are most recommended.

(V) Resin Coated Metal Sheet of Excellent Microwave Absorbability, Workability, Heat Releasing Property, Scratch Resistance and Fingerprint Resistance (Hereinafter Sometimes Referred to as a Fifth Coated Material)

This is a coated sheet satisfying the following (V-1) or (V-2) and also satisfying the following (V-3) to (V-5) in the first coated material.

(V-1) A heat releasing magnetic coating film which is the magnetic coating film described above and has the heat releasing property is coated on one surface of the metal sheet and, when the heat releasing magnetic coating film containing black additive, a resin coated film containing at least one of a white pigment and a luster pigment is coated selectively,

a heat releasing coating film and a resin coating film containing at least one of a white pigment and a luster pigment is coated to a thickness of 1 μm or more on the other surface of the metal sheet,

(V-1-i) at least one of the heat releasing magnetic coating film and the heat releasing coating film contains 1% or more of carbon black,

the surface not containing carbon black contains 10% or more of heat releasing additives other than carbon black; or

(V-1-ii) at least one of the heat releasing magnetic coating film and the heat releasing coating film contains 30% or more of titanium oxide, and

the surface not containing titanium oxide contains 1% or more of heat releasing additives other than titanium oxide.

(V-2) A heat releasing magnetic coating film which is the magnetic coating film and has heat releasing property is coated on both surfaces of a metal sheet,

(V-2-i) at least one surface of the heat releasing magnetic coating film contains 1% or more of carbon black,

the surface not containing carbon black contains 10% or more of heat releasing additives other than carbon black,

a resin coating film containing at least one of a white pigment and a luster pigment is coated to the heat releasing magnetic coating film on at least one surface, or

(V-2-ii) at least one surface of the heat releasing magnetic coating film contains 30% or more of titanium oxide,

the surface not containing titanium oxide contains 1% or more of heat releasing additives other than titanium oxide,

a resin coating film containing at least one of a white pigment and a luster pigment is coated to the heat releasing magnetic coating film on at least one surface.

(V-3) The integrated emissivity of infrared rays (wavelength: 4.5 to 15.4 μm) when the resin coated metal material is heated to 100° C. satisfies the following formula (1):
a×b0.42 formula (1)

a: integrated infrared emissivity on the surface (on the side of atmospheric air as viewed from the resin coated metal sheet).

b: integrated infrared emissivity on the rearface (inner side of the resin coated metal sheet).

(V-4) Each of the film thickness of the resin coated films is 0.5 to 10 μm and the addition amount of the white pigment and the luster pigment contained in the resin coating film is 1 to 25% in total.

(V-5) The tone of the resin coated metal sheet containing at least one of the white pigment and the luster pigment satisfies 44.0 to 60.0 of the L value as measured by a color difference meter (SZS-Σ90) manufactured by Nippon Denshoku Industries Co., Ltd.

(VI) Resin Coated Metal Sheet of Excellent Microwave Absorbability, Workability, Heat Releasing Property, Self-Cooling Property, Scratch Resistance and Fingerprint Resistance (Hereinafter Sometimes Referred to as a Sixth Coated Material)

This is a coated sheet satisfying the following (VI-1) or (VI-2) and also satisfying the following (VI-3) to (VI-5) in the first coated material.

(VI-1) The magnetic coating metal film is coated on one surface of a metal sheet, the magnetic coating film selectively contains black additive, and, when the magnetic coating film contains the black additives, a resin coating film containing at least one of a white pigment and a luster pigment is further coated selectively,

a black heat releasing coating film of 1 μm or more containing 1% or more of black additives and a resin coating film containing at least one of a white pigment and a luster pigment is coated on a second surface on the side opposite to the first surface.

(VI-2) The magnetic coating film is coated on both surfaces of a metal sheet, the magnetic coating film on the first surface of the metal sheet is a black heat releasing magnetic coating film of 1 μm or more containing 1% or more of black additives,

the magnetic coating film on the second surface on the side opposite to the first surface selectively contains 1% or more of heat releasing additives,

at least the black heat releasing magnetic coating film of them is coated with a resin coating film containing at least one of a white pigment and luster pigment.

(VI-3) The integrated emissivity of infrared rays (wavelength: 4.5 to 15.4 μm) when the resin coated metal material is heated to 100° C. satisfies the following formula (2) and the following formula (3).
b≦0.9 (a−0.05) formula (2)
(a−0.05)×(b−0.05)≧0.08 formula (3)

a: integrated infrared emissivity on the second surface of the resin coated metal sheet,

b: integrated infrared emissivity on the first surface of the resin coated metal sheet.

(VI-4) Each of the film thickness of the resin coated films is 0.5 to 10 μm and the addition amount of the white pigment and the luster pigment contained in the resin coating film is 1 to 25% in total.

(VI-5) The tone of the resin coated metal sheet containing at least one of the white pigment and the luster pigment satisfies 44.0 to 60.0 of the L value as measured by a color difference meter (SZS-Σ90) manufactured by Nippon Denshoku Industries Co., Ltd.

As the white pigment or the luster pigment, oxide series pigments are preferred and those containing titanium oxide are most recommended.

The first to sixth coated materials are useful, particularly, as a casing for electronic equipment components.

Further, the invention also includes electronic equipment parts incorporating a heat generating component in a closed space in which the electronic equipment part is constituted with the first to sixth coated material described above entirely or partially for the outer wall thereof.

With the constitution described above, the invention can provide a resin coated metal sheet capable of providing excellent microwave absorbability and workability and, optionally, providing heat releasing property; heat releasing property and self-cooling property; scratch resistance and fingerprint resistance, and electrical conductivity together and, particularly, useful as constituent materials in electronic equipment.

### BRIEF DESCRIPTION OF THE DRAWINGS

FIG. 1 is a view for explaining the principle of the microwave absorbability by a coated metal sheet according to the present invention.

FIG. 2 is a view for explaining the method of evaluation for a microwave absorbing performance in a coated metal sheet.

FIG. 3 is a graph for explaining the state in which an inputted microwave is decreased with the amount of reflection at the resonance frequency of a casing.

FIG. 4 is an explanatory view schematically showing the state upon measuring the microwave absorbability.

FIG. 5 is a graph showing a range of excellent heat releasing characteristics in a second coated material according to the invention.

FIG. 6 is a graph showing a range of excellent both in self-cooling property and dissipating property in a third coated material according to the invention.

FIG. 7 is a schematic view for an apparatus used for measurement of ΔT1 (heat releasing property) and ΔT2 (self-cooling property).

FIG. 8 is an explanatory view showing the outline of a first coated material.

FIG. 9 is an explanatory view showing the outline of a second coated material.

FIG. 10 is an explanatory view showing the outline of a fourth coated material.

FIG. 11 is a schematic view for a scratch resistance test.

### BEST MODE FOR CARRYING OUT THE INVENTION

As has been described above, the resin coated metal sheet according to the present invention includes the following embodiments (I) to (VI).
(I) Resin coated metal sheet excellent in microwave absorbability and workability (first coated material)
(II) Resin coated metal sheet additionally excellent in heat releasing property in the coated material (I) described above (second coated material).
(III) Resin coated metal sheet additionally excellent in heat releasing property and self-cooling property in the coated material (I) described above (third coated material).
(IV) Resin coated metal sheet additionally excellent in scratch resistance and fingerprint resistance the coated material (I) described above (fourth coated material).
(V) Resin coated metal sheet additionally excellent in heat releasing property, scratch resistance and fingerprint resistance the coated material (I) described above (fifth coated material).
(VI) Resin coated metal sheet additionally excellent in heat releasing property, self-cooling property, scratch resistance and fingerprint resistance in the first coated material (I) described above (sixth coated material).

In the subsequent description, in a case where when electronic equipment is manufactured by using the resin coated metal sheet according to the invention, the face on the side situated to atmospheric air is referred to as a surface and a face situated on the inner side is referred to as a rearface.

At first, description is to be made to (I) described above.

(I) Resin Coated Metal Sheet of Excellent Microwave Absorbability and Workability (First Coated Material)

The first coated material according to the invention has a feature in that a magnetic coating film containing 20 to 50% of magnetic powder is coated to a thickness of 3 to 50 μm to the rearface or the surface and the rearface of a metal sheet (herein rearface means the inner side of the resin coated metal sheet for use in electronic equipment components, while the surface means the side of atmospheric air as viewed from the resin coated metal sheet for use in electronic equipment components),

The background to reach the constitution described above is to be described briefly.

It has been known that microwaves generated from electronic equipment are often reflected from rather than absorbed to steel sheets. In view of the above, for providing a metal sheet excellent also in the microwave absorbability without deteriorating the workability, the present inventors have considered that when a relatively thin magnetic coating film is formed in a state incorporated with a magnetic powder by a required minimum amount at least to the rearface in a coated steel sheet constituting a microwave absorbing casing (inner lateral surface constituting the casing: referred to as “rearface” in the specification), microwaves generated inside the casing are put to multiple reflection, and attenuation for final leakage of microwaves through vent holes, etc. to the outside of the casing may be expected.

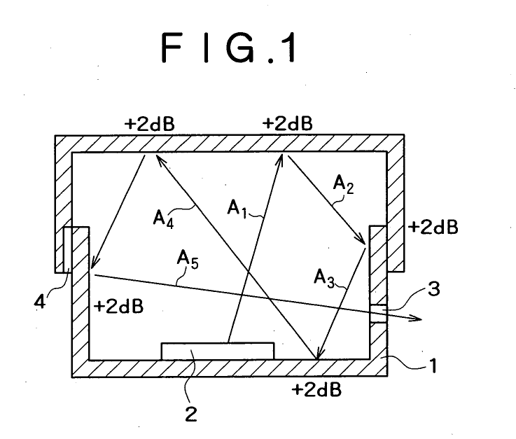

That is, as shown in FIG. 1 (view for explaining the principle of the microwave absorbability by the metal sheet according to the invention), in a case where a microwave generation source 2 is present in a casing 1, microwaves generated from the microwave generation source 2 are reflected for multiple times at the inner surface of the casing 1 as shown by arrows A1 to A5 and then leak through vent holes 3 or the like to the outside (in the drawing reference 4 represents a gap between casings). Then, assuming attenuation by the reflection for once (blank steel sheet ratio as 2 dB (decibel), a microwave shielding effect for example of 10 dB can be provided by multiple reflection for five times. The microwave attenuation effect, when compared with that obtained by the blank steel sheet alloy, means that the electric field intensity is reduced to ⅓. With the view point described above, each of the factors is defined for the coated metal sheet according to the invention.

Then, each of the factors constituting the first coated material is to be described.

At first, the magnetic film characterizing the coated material is to be described.

(I-1) Magnetic Powder Contained by 20 to 60% in Magnetic Coating Film

The magnetic powder (microwave absorbing additive) used in the invention has no particular restriction and can include, typically, soft magnetic ferrite powder and magnetic metal powder, which may be used alone or two or more of them may be used in combination.

However, in the use of any magnetic powder, the addition amount to the magnetic coating film should be 20 to 60% in total. In a case where the addition amount is less than 20%, it is difficult to provide the microwave absorbability, whereas if it exceeds 60%, the properties required as the resin coated metal sheet for use in electronic equipment components (bendability, film adhesion or corrosion resistance) tend to be degraded. A preferred addition amount is generally 25% or more and 50% or less and, more preferably, 30% or more and 45% or less although varying depending on the kind of the magnetic powder to be used or the thickness of the magnetic coating film (to be described later).

Among the magnetic powders, the soft magnetic ferrite powder can include, for example, soft magnetic Ni—Zn based ferrite powder and Mn—Zn powder.

Further, the magnetic metal powder can include, for example, permalloy (Ni—Fe based alloy with Ni content of 35% or more) and sendust (Si—Al—Fe based alloy). Typically, those described in examples to be shown below may be used.

In the coated material described above, it is sometimes desired to improve also the electrical conductivity in addition to the improvement of the microwave absorbability and the workability. In this case, use of the magnetic metal powder is particularly useful among the magnetic powders described above, and the electrical conductivity can also be increased by merely adding the magnetic metal powder to the magnetic coated film. This is because Ni useful as the electrically conductive additive is already contained in the magnetic metal powder.

On the other hand, in a case of using the soft magnetic ferrite powder among the magnetic powders described above, it is difficult to improve the electrical conductivity by the powder alone. Accordingly, in a case where the improvement for the electrical conductivity is intended as well, it is preferred to add a electrically conductive additive (conductive filler) to be described later in addition to the soft magnetic ferrite powder into the magnetic coating film and it is preferred to properly control the content (to be described later).

The average particle size of the magnetic powder is preferably 15 μm or less and it is preferred that the powder of larger particle size (for example, 20 μm or more) is removed as much as possible. This can facilitate the formation of the magnetic coating film and can suppress deterioration of the workability and the corrosion resistance.

The average particle size of the magnetic powder means 50% particle size (D50) obtained by measuring the particle size distribution of the magnetic powder particles after classification by a general particle size distribution meter, and from the particle size for 50% accumulated value from the side of a smaller particle size calculated based on the result of the measurement. Such a particle size distribution can be measured by an intensity pattern for diffraction or scattering caused by irradiating light to the magnetic powdery particles and examples of the particle size distribution meter can include, for example, microtrack 9220FRA or microtrack HRA manufactured by Nikkiso Co.

For the magnetic powder satisfying the preferred average particle size described above, commercial products may also be used. For example, they can include those magnetic powders described in subsequent examples.

(I-2) Magnetic Coating Film Thickness of 3 to 50 μm

Further, in the invention, the thickness of the magnetic coating film is defined as 3 to 50 μm. In a case where the film thickness is less than 3 μm or more than 50 μm, the bendability, the film adhesion and the corrosion resistance are deteriorated. A preferred film thickness is generally 4 μm or more and 40 μm or less and, more preferably, 5 μm or more and 30 μm or less while it may vary, for example, depending on the kind and the addition amount of the magnetic powder to be used.

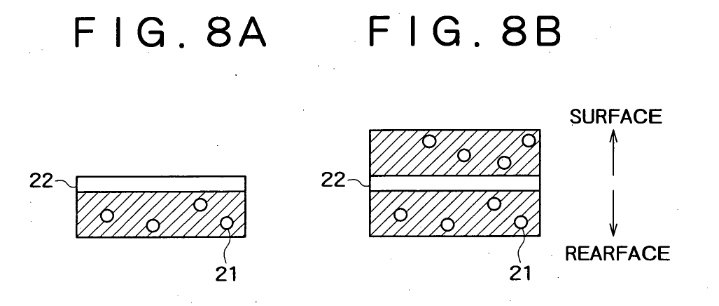

The magnetic film described above may be formed at least to the rearface of the metal sheet (inner side of the resin coated metal sheet for use in electronic equipment component). This is because the microwave shielding property is considered at the inside of the electronic equipment compartment. Specifically, the first coated material includes, as shown in FIG. 8, both an embodiment where a magnetic film is coated on the rearface (FIG. 8(a)) and a case where the magnetic films are coated on the surface and the rearface (FIG. 8(b)). In FIG. 8, are shown a magnetic powder 21 and a metal sheet 22.

The foregoings are descriptions regarding the characteristic portion of the magnetic coating film in the invention.

The kind of the resin constituting the magnetic coating film (base resin) has no particular restriction with a view point of the microwave absorbability and acrylic resin, epoxy resin, urethane resin, polyolefin resin, polyester resin, fluoro resin, silicon resin, mixed or modified resins derived therefrom can be used properly. However, since the coated metal sheet of the invention is used as the casing for the electronic equipment, it is preferably a polyester resin or a modified polyester resin (for example, a resin obtained by modifying an unsaturated polyester resin with addition of an epoxy resin) considering the required characteristics such as bendability, film adhesion and corrosion resistance. A crosslinker may be added to the magnetic coating film. The crosslinker can include, for example, melamine compounds or isocyanate compound and one or more of them can be them preferably added within a range from 0.5 to 20%.

On the other hand, in a case where it is intended to improve the microwave absorbability of the coated material, it has been known that this may be attained by providing electroelectrical conductivity. With the view point, a method of adding an electrically conductive additive to the magnetic coating film is useful. The electrically conductive additive can include metallic elements such as Ag, Zn, Fe, Ni and Cu or metal compounds such as FeP. Among them, Ni is particularly preferred. Further, while there is no particular restriction on the shape it is recommended to use a flaky material for obtaining superior electrical conductivity.

Generally, the addition amount of the electrically conductive additive is preferably from 20 to 40% in the magnetic coating film and, strictly, it is recommended to properly control the addition amount in accordance with the kind, etc. of the magnetic powder to be used. As has been described above, in a case of using the soft magnetic ferrite powder for the magnetic powder, since it cannot provide the electrical conductivity by itself, it is preferred that the electrically conductive additive is added in an amount as much as possible within the range described above (for example, 25% or more). On the contrary, in a case of using the magnetic metal powder for the magnetic powder, since it has the electrical conductivity of itself, it is preferably added in an amount as less as possible (for example 30% or less) within the range described above (20 to 40%).

On the other hand, considering that the electrically conductive additive may have a worry of giving undesired effects on the workability or the like in the same manner as in the magnetic powder, the total content of the electrically conductive additive and the magnetic powder contained in the magnetic coating film is preferably 60% or less.

Considering the foregoing collectively, in a case where both of the magnetic powder and the electrically conductive additive are added in the magnetic coating film and, at first, when the soft magnetic ferrite powder is used as the magnetic powder, it is preferred that the content of the ferrite powder is about 20 to 40% and the content of the electrically conductive additive is from 20 to 40% (60% or less in total) and, on the other hand, when the magnetic metal powder is used as the magnetic powder, it is preferred that the content is about 30 to 50% and the content of the electrically conductive additive is from 10 to 30% (60% or less in total).

Further, the metal sheet used in the invention has no particular restriction and any of known metal sheets can be applied, for example, steel sheets such as cold rolled steel sheets, hot rolled steel sheets various plates sheets such as electrically galvanized steel sheets (EG), molten galvanized steel sheets (GI), molten galvanized alloy steel sheets (GA), 5% Al—Zn galvanized steel sheets, 55% Al—Zn galvanized steel sheets and Al, and stainless steel, and known metal sheets.

Further, the metal sheets may be applied with a surface treatment such as chromation or phosphatization with an aim of improving for the corrosion resistance and improving for the adhesion of coated films and, on the other hand, a metal sheet applied with non-chromate treatment may also be used in view of environmental pollution and all of them are included within the range of the invention.

A metal sheet applied with non-chromate treatment is to be described.

The method for “non-chromate treatment” (primer treatment) has no particular restriction and known primer treatment used customarily may be applied. Specifically, it is recommended that the primary treatment using phosphate type, silica type, titanium type or zirconium type compounds may be applied alone or in combination.

Since the corrosion resistance is generally worsened when the non-chromate treatment is applied, an anti-rusting agent may also be used in the black coating film or upon primary treatment. The anti-rusting agent can include, for example, silica type compound, phosphate type compound, phosphite type compound, polyphosphate type compound, organic sulfur type compound, benzotriazole, tannic acid, molybdate type compounds, tungstate type compounds, vanadium type compound, and silane coupling agent, which may be used alone or in combination. Particularly preferred are combined use of the silica compound (for example, calcium ion exchanged silica or the like), and phosphate type compound, phosphite type compound, polyphosphate type compound (for example, aluminum tripoly phosphate), and it is recommended to use the silica type compound (for example, calcium ion-exchanged silica) together with phosphate type compound, phosphite type compound or polyphosphate type compound (for example, aluminum tripoly phosphate) at a mass ratio within a range 0.5 to 9.5:9.5 to 0.5 (more preferably, 1:9 to 9:1). By controlling to the range described above, both desired corrosion resistance and workability can be ensured.

While the corrosion resistance of the non-chromate treated metal sheet can be ensured by the use of the anti-rusting agent, it is also known that the workability is deteriorated by the addition of the anti-rusting agent on the other hand. Accordingly, it is recommended to use, as the ingredient for forming the black coating film, in combination, a polyester resin, particularly, epoxy modified polyester modified and/or polyester resin with phenolic derivative introduced into the skeleton, and a crosslinker (preferably, isocyanate resin and/or melamine resin, preferably, combined use of both of them).

Among them, the epoxy modified polyester resin and the polyester resin introduced with the phenolic derivative to the skeleton (for example, polyester resin introduced with bisphenol A to the skeleton) is excellent in the corrosion resistance and the coating film adhesion compared with the polyester resin.

On the other hand, the isocyanate crosslinker has an effect of improving the workability (means the effect of improving the appearance after processing, which is evaluated by the number of cracks in the adhesion bending test in the examples to be described later), which enables to ensure excellent workability even with addition of the anti-rusting agent.

Further, it has been found by the result of the study according to the present inventors that the melamine crosslinker has excellent corrosion resistance. Accordingly, excellent corrosion resistance can be obtained in the invention by the combined use with the anti-rusting agent described previously.

The isocyanate crosslinker and the melamine crosslinker may be added alone, but combined use of both of them can further improve the workability and the corrosion resistance in the non-chromate treated metal sheet. Specifically, it is recommended to incorporate the melamine resin at a ratio of from 5 to 80 mass parts based on 100 mass parts of the isocyanate resin. In a case where the melamine is less than 5 mass parts, no desired corrosion resistance can be obtained, whereas if the melamine resin exceeds 80 mass parts, the effect by the addition of the isocyanate resin cannot be provided satisfactorily failing to obtain a desired effect for improving the workability. More preferably, the amount is 10 mass parts or more and 40 mass parts or less and, further preferably, 15 mass parts or more and 30 mass parts or less based on 100 mass parts of the isocyanate resin.

Then, description is to be made to the second coated material of the invention (resin coated metal sheet superior in the heat releasing property in the coated material (1) described above) and the third coated material of the invention (coated material superior in the heat releasing property and the self-cooling property in the coated material (1) described above). At first, a basis idea in common with them is to be described.

For providing a coated material for use in electronic equipment components capable of attaining lowering of the internal temperature of electronic equipment (heat releasing property) while satisfying primary characteristics required for the electronic equipment (ensuring air tightness along with water proofness and dust proofness, reduction in the size and the weight and decrease in the cost, etc.) in the first coated material the present inventors have made earnest study, particularly, mainly for the improvement of the heat releasing property of the coated material itself. As a result, it has been found that the intended purpose can be attained by coating a predetermined coating film to the surface and the rearface of the metal sheet.

The mechanism is “absorption of heat released from a heat source (heat generation body) inside an electronic equipment (radiation heat) to the coating film at the rearface (radiation), and radiation of the heat from the heat releasing coating film on the surface” and it has a most prominent feature in skillfully applying the concept of a so-called “heat through system” to electronic equipment components. The coated material obtained by applying the concept of “heat through system” to electronic equipment components and absorbing→radiating the amount of heat released from the electronic equipment as “rearface of metal sheet”→“surface of metal sheet” has not yet been known so far and is novel.

Then, before explanation for each of the coated materials, description is to be made to a relation between the second coated material (coated material of excellent heat releasing property) and the third coated material (coated material of excellent in heat releasing property and self-cooling property).

The fundamental idea is identical between the second coated material and the third coated material with respect to application of the concept of “heat through” described previously to the electronic equipment components thereby intending to improve the heat releasing property. However, they are different in the subject to be solved intended finally (principal subject to be solved), as well as in the technical idea and the constitution for solving the subject. That is, in the second coated material, improvement of the heat releasing property (lowering of the internal temperature in the electronic equipment) is the greatest subject to be solved, and the constitution of the heat releasing coating film is specified while considering the surface and the rearface integrally that constitute the heat releasing coating film under the idea that “the product of the infrared ray emissivity for the surface and the rearface is preferably as large as possible”. On the other hand, in the third coated material, “suppression of the temperature rise of the coated material itself” while maintaining the heat releasing characteristics to some extent by utilizing the “idea of heat through” described above is the greatest subject to be solved and the constitution of the coating films on the surface and the rearface are considered and controlled separately under the idea that “a positive difference is provided for the infrared ray absorption emissivity between the surface and the rearface, the infrared ray emissivity at the rearface is made lower than that of the surface and the infrared ray emissivity at the surface is increased as much as possible, thereby releasing heat absorbed in the coated material. In this regard, both of them can be said to be inventions having the aimed direction being different between each other.

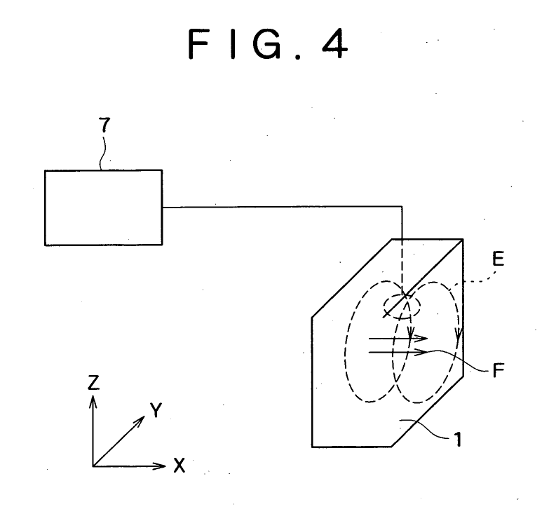

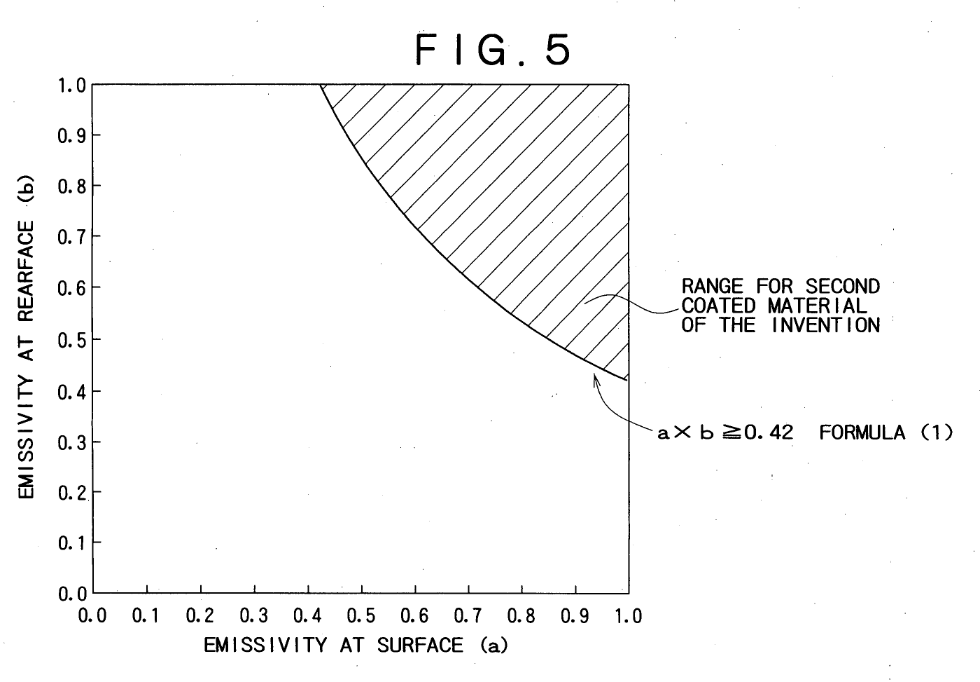

That is, while the second coated material is excellent in the heat releasing property, it involves an aspect that it is inferior in the self-cooling property. On the other hand, while the third coated material is excellent in the self-cooling property, it also invovles an aspect that the heat releasing property is somewhat inferior when compared with the second coated material. For making the difference between both of them clearer, FIG. 5 shows a region defined by the second coated material [region excellent in the heat releasing property satisfying the formula (1)] and FIG. 6 shows a region defined by the third coated material [overlap portion between the range of excellent heat releasing property satisfying the formula (3) and the range of excellent self-cooling property satisfying the formula (2)], respectively. The coated materials also include a portion overlapping with each other [excellent in the heat releasing property since the product of the infrared ray emissivity for the surface and rearface is high and also excellent in the self-cooling property since the infrared ray emissivity on the surface is higher compared with that of the rearface], and the portion is a region excellent in both the heat releasing property and the self-cooling property.

Each of the coated materials according to the invention is to be described.

(II) Resin-Coated Metal Sheet Further Excellent in the Heat Releasing Property in the Coated Material (I) Described Above (Second Coated Material)

The second coated material has been accomplished on the basis of the fundamental idea described above and it has a feature in satisfying (II-1) or (II-2) described above and also satisfying (II-3) described above thereby improving the heat releasing property in the first coated material described previously.

At first, the purpose of defining (II-1) or (II-2) described above is to be explained.

As has been described above, the coated material as the basic embodiment of the invention (first coated material) is required to have excellent microwave absorbability at least on the rearface (inner side of the coated material for use in electronic equipment components). Accordingly, also in the second coated material, it is generally classified into a mode (II-1) in which the magnetic coating film is formed only on the rearface like the first coated material and an embodiment (II-2) in which the magnetic coating film is formed on the surface and the rearface.

On the other hand, with a view point of improving the heat releasing property, a heat releasing coating film of 1 μm or more is formed to the surface and the rearface of the metal sheet, and (i) carbon black is added to at least one of the heat releasing coating films and it is necessary that heat releasing additives other than carbon black are the surface not containing the carbon black, or (ii) titanium oxide is added to at least one of the heat releasing coating films and it is necessary to add heat releasing additives other than titanium oxide to the surface not containing titanium oxide, thereby enabling to ensure desired heat releasing property [(II-3) described above].

As has been described above, the second coated material is defined while considering the factor required for the improvement of the microwave absorbability and workability and the factor required for the improvement of the heat releasing property.

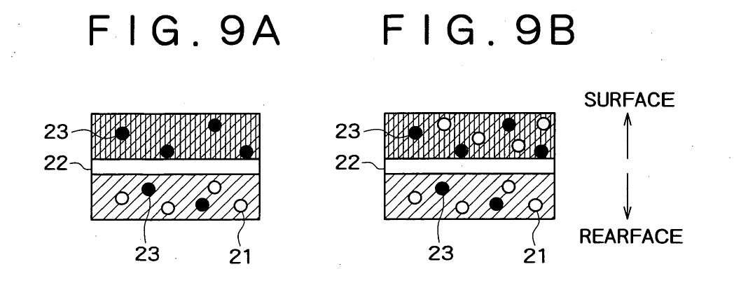

Embodiment (II-1) or (II-2) is to be described with reference to FIG. 9.

(II-1) Embodiment in Which the Magnetic Coating Film Satisfying the Factor Described Previously is Formed Only on the Rear Face of a Metal Sheet [FIG. 9(a)]

In this embodiment, a magnetic coating film of 3 to 50 μm is formed at the rearface. Accordingly, for obtaining a desired heat releasing property, it is necessary to coat a heat releasing coating film of 1 μm or more on the surface on the opposite side (thus, coating films are formed on both surface and rearface) and it is necessary to add heat releasing additives (heat releasing additives) in each of the coating films for forming the heat releasing coating film on the surface and the rearface (refer to FIG. 9(a)). In the drawing, are shown a magnetic powder 21, a metal sheet 22 and heat releasing additives 23.

Further, for ensuring a desired heat releasing property (refer to (II-3)) defined for the second coated material, it is necessary to add carbon black (or titanium oxide) of particularly high emissivity as heat releasing additives to the coating film on at least one surface, and heat releasing additives other than the carbon black (or heat releasing additive other than titanium oxide) are added to the surface not containing the carbon black (or the surface not coating titanium oxide). Since a coated material of further excellent heat releasing property can be obtained when adding carbon black (or titanium oxide) to both surfaces, it is extremely useful.

In view of the foregoings, it is defined in (II-1) above that at least one of the magnetic coating film on the rearface and the heat releasing coating film on the surface contains carbon black (or titanium oxide), and that the heat releasing additives other than carbon black (or heat releasing additives other than titanium oxide) are contained in the surface not containing carbon black (or surface not containing titanium oxide).

Explanation is to be described orderly.

(II-1-i) At Least One of the Magnetic Coating Film or the Heat Releasing Film Contains 1% or More of Carbon Black and the Surface Not Containing the Carbon Black Contains 10% or More of the Heat Releasing Additives Other Than Carbon Black

Carbon black is a black additive having an excellent heat releasing property and it is recommended in the invention that surface at least one of the magnetic coating film or the heat releasing coating film contains carbon black in order to obtain a desired heat releasing property.

At least one of the magnetic coating film or the heat releasing coating film may contain only the carbon black but other black additives or heat releasing additives other than black additive may also be used together (examples will be described later). However, for ensuring a desired heat releasing property, it is recommended to control the ratio of the carbon black in the black additives to 10% or more (preferably, 30% or more and, more preferably, 50% or more). Since carbon black has a specific gravity lower than that of other typical black additives (such as oxide additives), it can effectively provide a desired heat releasing effect even when used at a smaller ratio when converted by mass ratio. A black coating film in which the black additives consist only of carbon black is the most preferred.

The content of carbon black contained in the coating film has to be controlled properly in relation with the thickness of the coating film and it is recommended to add by 1% or more. Basically, since more excellent heat releasing property can be obtained as an addition amount of the carbon black is larger, it is preferably added by 3% or more and, more preferably, 5% or more. While the upper limit of the addition amount has no particular restriction in view of the heat releasing property, the coatability is worsened and the scratch resistance or the like is also deteriorated when it exceeds 15%. Accordingly, when the coatability or the like is taken into consideration, the upper limit is preferably less than 15% and 13% and 12% in the further preferred order.

Addition amount of the carbon black in the coating film can be measured by the following method.

At first, a specimen (sample for analysis) is heated with addition of a solvent to decompose organic matters in the specimen. The kind of the solvent to be used may vary depending on the kind of the base resin, and an appropriate solvent may be used properly in accordance with the solubility of each resin. For example, in a case of using a polyester resin or a urethane resin as the base resin, the specimen is added to a vessel (egg-type flask) to which a methanol solution of sodium hydroxide is added and the vessel is heated in a water bath at 70° C. to decompose organic matters in the specimen.

Then, the organic matters are separated by filtration through a glass filter (0.2 μm pore size) and carbon in the obtained residue is determined by combustion infrared absorption spectroscopy to calculate the concentration of carbon black in the coating film.

Further, the average particle size of the carbon black is controlled preferably to 5 to 100 nm. When the average particle size is less than 5 nm, no desired heat releasing property can be obtained and, in addition, the stability of the coating material is poor and the appearance of coating is deteriorated. On the other hand, when the average particle size exceeds 100 nm, not only is the heat releasing property lowered but also the appearance after coating becomes not uniform. It is preferably 10 nm or more and 90 nm or less and, more preferably, 15 nm or more and 80 nm or less. When considering the coating film stability, the uniformness of the appearance after coating, etc. collectively in addition to the heat releasing property, the optimal average particle size of the carbon black is recommended to be about from 20 to 40 nm.

In the invention, commercial products may be used for the carbon black satisfying the average particle size described above and, for example, use of “MITSUBISHI Carbon Black” (average particle size: 13 to 75 μm) manufactured by MITSUBISHI CHEMICAL CORPORATION is recommended. The average particle size of the black additives used in the invention may be calculated based on the arithmetic average diameter obtained by an electron microscope as described in the pamphlet for the commercial products described above.

Further, for the heat releasing additives other than carbon black described above (“heat releasing additives other than CB”), black additives can include, for example, oxides, sulfides and carbides of Fe, Co, Ni, Cu, Mn, Mo, Ag, and Sn, and black fine metal powder; and the heat releasing additives other than the black additives can include, for example, ceramics such as. TiO₂, zirconia, cordierite, aluminum titanate, β-spodumene, silicon carbide, aluminum nitride, hexagonal system boron nitride, iron oxide, barium sulfate, silicon oxide and aluminum oxide; and Al powder (flaky Al flakes). They may be used alone or two or more of them may be used in combination. In order to ensure a desired heat releasing property, the content of the “heat releasing additives other than CB” in total is 10% or more, preferably, 20% or more and, more preferably, 30% or more.

Among them, preferred are ceramics such as TiO₂, and Al flakes, and more preferred is TiO₂.

For example, in a case of using TiO₂, when a coating film containing about 30 to 70% of TiO₂ is formed to about 5 to 50 μm, infrared ray emissivity of about 0.8 can be obtained. When black additives such as carbon black are added to the coating film, the infrared ray emissivity further increases. Further, when it is intended to provide a surface with a metallic appearance, it is recommended to use Al flakes for the coating film on the surface. In this case, an infrared emissivity of about 0.6 to 0.7 can be obtained with the content of the Al flake of 5 to 30% and the thickness of the coating film of about 5 to 30 μm.

Commercial products may be used as the heat releasing additives capable of satisfying the average particle size and it is recommended to use, for example, TiO₂ (average particle size 0.2 to 0.5 μm) manufactured by TAYCA CORPORATION as TiO₂; and LB584 (average particle size: 25 μm), manufactured by SHOWA ALUMINUM POWDER K.K. as the Al flakes. The average particle size of “heat releasing additives” used in the invention may be calculated based on the arithmetic average diameter by using an electron microscope as describe in the pamphlet for the commercial products of the carbon black described above [“MITSUBISHI Carbon Black”, manufactured by MITSUBISHI CHEMICAL CORPORATION (average particle size; 13 to 75 μm)] described above.

(II-1-ii) At Least One of the Magnetic Coating Film or the Heat Releasing Coating Film Contains 30% or More of Titanium Oxide; and the Surface Not Containing Titanium Oxide Contains 1% or More of the Heat Releasing Additive Other Than Titanium Oxide

In the second coated material, titanium oxide may be used instead of carbon black. This is because titanium oxide is heat releasing additives of high emissivity next to the carbon black.

In a case of using titanium oxide, the addition amount is 30% or more (preferably, 40% or more) and the surface not containing titanium oxide contains 1% or more (preferably, 3% or more) of the heat releasing additives other than titanium oxide (“heat releasing additives other than CB” described above, except for titanium oxide and, further containing carbon black). Details for them are as described above. Thickness of heat releasing coating film on the surface: 1 μm or more

In any of (II-1-i) and (II-1-ii), it is necessary that the thickness of the heat releasing coating film at the surface is 1 μm or more. The lower limit is determined in order to ensure a desired heat releasing property and, when the thickness is less than 1 μm, no desired heat releasing property can be obtained even when a great amount of the heat releasing additives is added. The lower limit is preferably in the order of 3 μm, 5 μm, 7 μm and 10 μm.

The upper limit has no particular restriction in relation with the heat releasing property. However, considering the requirement for the improvement of the workability in view of the intended application to electronic equipment parts, and, particularly, considering prevention for the occurrence of crackings or peeling of the coating film during bending processing, it is recommended that the thickness is controlled to 50 μm or less (preferably, in the order of 45 μm or less, 40 μm or less, 35 μm or less and further 30 μm or less).

For further providing good workability and ensuring excellent electrical conductivity as well, it is recommended to control the thickness to 12 μm or less (more preferably, 11 μm or less and, further preferably, 10 μm or less).

The kind of the resin added to the coating film at the surface and the rearface (base resin forming the heat releasing coating film) has no particular restriction in view of the heat releasing property, and acrylic resin, urethane resin, polyolefin resin, polyester resin, fluoro resin, silicon resin, and mixed or modified resins derived therefrom can be used appropriately. Since the coated material of the invention is used as the casing for electronic equipment, when the requirement for the improvement of the workability in addition to the heat releasing property is also taken into consideration, the base resin is preferably non-hydrophilics resin [specifically, those satisfying an angle of contact with water of 30° or more (more preferably, 50° or more and, further preferably, 70° or more)]. While the resin satisfying such non-hydrophilic property may vary depending on the extent of mixing or modification, use, for example, of polyester resin, polyolefin resin, fluoro resin or silicon resin is preferred and, among all, use of the polyester resin is recommended.

Further, in addition to the carbon black/titanium oxide, a pigment such as an anti-rusting pigment or silica may also be added to the coating film within a range not deteriorating the effect of the invention. Alternatively, other heat releasing additives than those described above [for example, ceramics such as zirconia, cordierite, aluminum titanate, β-spodumene, silicon carbide, aluminum nitride, hexagonal system boron nitride, iron oxide, barium sulfate, silicon oxide and aluminum oxide; and Al powder (flaky Al flakes) alone or two or more of them in combination] may also be added within a range not deteriorating the effect of the invention.

Further, a crosslinker can be added to the coating film. The crosslinker used in the invention can include, for example, melamine compounds or isocyanate compounds and it is recommended to add the crosslinker alone or in combination of two or more of them within a range from 0.5 to 20% by weight.

(II-2) Embodiment in Which the Magnetic Coating Film Satisfying the Factor Described Above is Formed to Surface and the Rearface of Metal Sheet [FIG. 9(b)]

A magnetic coating film of 3 to 50 μm is formed at the surface and the rearface. For obtaining a desired heat releasing property, it is necessary to form the magnetic coating film as a heat releasing coating film and, for this purpose, it is necessary to add heat releasing additives to each of the coating films (refer to FIG. 9(b)).

Specific constitution is identical with that in the second coated material (II-1) described above.

(II-3)
a×b≧0.42 Formula (1)

a and b in the relation represents the integrated infrared emissivity a on the surface and the integrated infrared emissivity b on the rearface respectively in the integration radiation ratio for infrared rays (wavelength: 4.5 to 15.4 μm) when coated materials in which a coating film is coated on the surface and the rearface of the metal sheet is heated to 100° C.

The infrared ray integrated emissivity described above is measured by a method to be described later, and the infrared ray integrated emissivity at the surface or the rearface can be separately measured respectively.

The “infrared ray integrated emissivity” described above means, in other words, easiness for emitting infrared rays (heat energy). Accordingly, higher infrared ray emissivity means increase in the amount of heat energy to be emitted (absorbed). For example, in a case where heat energy applied to an object (coated material in the invention) is radiated by 100%, the infrared ray integrated emissivity is 1.

In the invention, “the infrared ray integrated emissivity” is defined when heating at 100° C. The heating temperature is determined as 100° C. considering that the coated material according to the invention is applied for the use in electric equipment (usual atmospheric temperature is generally at about 50 to 70° C. and about 100° C. at the maximum while it varies depending on the components), so as to align with the temperature in the practical level.

The method of measuring the integrated infrared ray emissivity is as described below.
Apparatus: “JIR-5500 Furrier infrared photospectrometer” and radiation measuring unit “IRR-200” manufactured by JOEL Ltd.
Measuring wavelength range: 4.5 to 15.4 μm
Measuring temperature: Specimen heating temperature is set to 100°C.
Number of accumulation: 200 times
Resolution power: 16 cm⁻¹

Using the apparatus described above, the spectral radiation intensity of a specimen (measured value) in an infrared wavelength region (4.5 to 15.4 μm) was measured. Since the measured value for the specimen is measured as a value with addition/attachment of the background radiation intensity and the apparatus function, the integrated emissivity was calculated by using a emissivity measuring program [emissivity measuring program manufactured by JOEL Ltd.] with an aim of correcting the same. Details for the calculation method are as shown below.

$$ɛ ( λ ) = \frac{\frac{M ( λ , T )}{A ( λ )} - {K}_{FB} ( λ ) - {K}_{TB} ( λ , {T}_{TB} )}{{K}_{B} ( λ , T ) - {K}_{TB} ( λ , {T}_{TB} )}$$

$$E ( T ) = \frac{{\int }_{λ 1}^{λ 2} ɛ ( λ ) \cdot {K}_{B} ( λ , T ) \cdot ⅆ λ}{{\int }_{λ 1}^{λ 2} {K}_{B} ( λ , T ) \cdot ⅆ λ}$$

in which
ε(λ): spectral emissivity of specimen at a wavelength λ(%)
E(T): integrated emissivity of specimen at a temperature T(° C.)%)
M(λ, T): spectra radiation intensity of specimen (measured value) at the wavelength λ and the temperature T(° C.)
A(λ): apparatus function
KFB(λ): spectral radiation intensity for fixed background at the wavelength λ (background not varying depending on the specimen)
KTB(λ,TTB): spectral radiation intensity for a trap black body at wavelength λ and the temperature TTB(° C.)
KB(λ,T): spectral radiation intensity of the black body at the wavelength λ, and the temperature T(° C.) (calculated value according to Planck's theoretical formula)
λ1, λ2: wavelength range for integration

A (λ: apparatus function) and KFB (λ: spectral radiation intensity for fixed background) were calculated according to the following formulae based on the measured value for the spectral radiation intensity for two black body furnaces (80° C., 160° C.) and the spectral radiation intensity for black body in the temperature region (calculated value according to Planck's theoretical formula).

$$A ( λ ) = \frac{{M}_{180 °C} ( λ , 160 °C ) - {M}_{80 °C} ( λ , 80 °C )}{{K}_{180 °C} ( λ , 160 °C ) - {K}_{80 °C} ( λ , 80 °C )}$$

$${K}_{FB} ( ν ) = \frac{\begin{matrix}{K}_{180 °C} ( λ , 160 °C ) - {M}_{80 °C} ( λ , 80 °C ) - \\ {K}_{80 °C} ( λ , 80 °C ) \cdot {M}_{160 °C} ( λ , 160 °C )\end{matrix}}{{M}_{180 °C} ( λ , 160 °C ) - {M}_{80 °C} ( λ , 80 °C )}$$

in which
M160° C. (λ, 160° C.) means:

spectral radiation intensity for black body furnace at 160° C., at a wavelength λ (measured value)
M80° C. (λ, 80° C.) means:

spectral radiation intensity for black body furnace at 80° C., at a wavelength λ (measured value)
K160° C. (k, 160° C.) means:

spectral radiation intensity for black body furnace at 160° C., at a wavelength k (calculated value according to Planck's theoretical formula), and
K80° C. (λ, 80° C.) means:

spectral radiation intensity for black body furnace at 80° C., at a wavelength k (calculated value according to Planck's theoretical formula), respectively.

Upon calculation for the integrated emissivity E (T=100° C.), KTB (λ, TTB) is taken into consideration, because a water cooled trap black body is disposed at the periphery of the specimen upon measurement. By the provision of the trap black body, the spectral radiation intensity for the fluctuating background radiation (means background radiation that fluctuates depending on the specimen. Since radiation from the periphery of the specimen is reflected at the specimen surface, measured value for the spectral radiation intensity of the specimen appears as a value with addition of the background radiation) can be controlled low. For the trap black body, a pseudo black body at a emissivity of 0.96 is used and the KTB [(λ, TTB): spectral radiation intensity of a trap black body at a wavelength λ, at temperature TTB (° C.)] is calculated as described below.
KTB(λ, TTB)=0.96×KB(λ, TTB)
in which KB (λ, TTB) means the spectral radiation intensity of a black body at wavelength λ, temperature TTB (+ C.).

The second coated material according to the invention can satisfy the integrated emissivity for infrared rays (wavelength 4.5 to 15.4 μm) measured as described above [E (T=100° C.) described above] in which the product (a×b) for a and b described above is 0.42 or more (formula (1)). The value calculated by “a×b” (product of integrated emissivitys of infrared rays emitted from the coated material) is useful as an index showing the heat releasing effect of the coated material per se, and since the coated material satisfying the above mentioned formula can provide high radiation property in average in the wavelength region, the aimed level for the heat releasing property in the first coated material was defined as “a×b≧0.42”. A larger value for “a×b” (1 at the maximum) provides more excellent heat releasing property as it approaches 1 and it is 0.49 or more, 0.56 or more, 0.61 or more, 0.64 or more and 0.72 or more in the preferred order.

In the second coated material, the relation between the infrared ray emissivity at the surface and the infrared emissivity at the rearface has no particular restriction so long as the aimed level for the heat releasing property is satisfied and it includes both an embodiment in which the infrared ray emissivity is different between the surface and the rearface and an embodiment in which both surfaces have about the same emissivity. On the other hand, the third coated material according to the invention has a principal object in the improvement of the self-cooling property in addition to the heat releasing property and it is defined only to a coated material having higher infrared ray emissivity at the surface compared with that at the rearface and in this regard, they are different [details will be described in the chapter for the third coated material].

Specifically, so long as the heat releasing property defined in the formula (1) described above “a×b≧0.42” is satisfied, arbitrary infrared ray emissivity can be defined for surface/rearface. However, since the maximum value of the infrared ray emissivity is 1, it is necessary that the infrared ray emissivity at least on one surface is 0.42 or more for satisfying the formula (1); the infrared ray emissivity at least on one surface is 0.56 or more for satisfying a×b≧0.56; and the infrared ray emissivity on at least one surface is 0.64 or more for satisfying a×b≧0.64.

A larger infrared ray emissivity at one surface is more preferred and, in a preferred embodiment, infrared ray emissivity on at least one surface satisfies 0.65 or more. It is 0.7 or more, 0.75 or more, and 0.8 or more in the preferred order. The coated material having the rate on both surfaces of 0.65 or more is further preferred.

Further, in the second coated material, it is preferred that the difference (A−B) between the maximum value A and the minimum value B of the spectral emissivity is 0.35 or less in an arbitrary wavelength region of the infrared rays (wavelength 4.5 to 15.4 am). “A−B” represents “variation range of the emissivity” in the infrared ray wavelength region and “A−B≦0.35” shows that a stably high radiation property can be provided in any of the infrared ray wavelength regions. Accordingly, those capable of satisfying the factors described above are expected to be applicable to extended range of use in electronic equipment components, for example, as applicable for use in electronic equipment mounting various parts having different wavelength of infrared rays to be emitted. Specifically, an arbitrary emissivity measured as described above is measured and the difference (A−B) between the maximum value (A) and the minimum value (B) for the spectral emissivity in the wavelength region is calculated as “variation range of the emissivity”. More stable heat releasing property can be obtained as the value for “A−B” is smaller and it is more preferably 0.3 or less and, further preferably, 0.25 or less.

(III) Coated Material of Further Excellent Heat Releasing Property and Self-Cooling Property in the Coated Product (I) (Third Coated Material)

The third coated material is accomplished based on the fundamental idea described above and has a feature in enhancing the heat releasing property and the self-cooling property by satisfying (III-1) or (III-2) described above and satisfying (III-3) described above in the first coated material.

At first, the purpose of determining (III-1) and (III-2) described above is to be described.

Since the third coated material is required as well to have excellent microwave absorbability and workability as the premise, it is necessary that the magnetic coating film is formed at least on the rearface and, specifically, it includes two embodiments, that is, an embodiment in which the magnetic coating film is formed only on the rearface (III-1) and an embodiment in which the magnetic coating film is formed on the surface and the rearface (III-2).

On the other hand, with a view point of improving the heat releasing property and the self-cooling property, it is necessary that a heat releasing coating film of 1 μm or more is formed to the surface of the metal sheet (the magnetic coating film on the rearface is not always a heat releasing coating film) and that the heat releasing coating film on the surface and the magnetic coating film on the rearface contain heat releasing additives, by which desired heat releasing property and self-cooling property [(refer to (III-3) described above] can be ensured.

As described above, the third coated material is defined while considering the factor required for the improvement of the microwave absorbability and the factor required for the improvement of the heat releasing property and the self-cooling property into consideration.

Embodiments (III-1) and (III-2) are to be described respectively.

{III-1) Embodiment in Which the Magnetic Coating Film Satisfying the Factor Described Above is Formed Only at the Rearface of the Metal Sheet

In this embodiment, a magnetic coating film of 3 to 50 μm is formed on the rearface. Accordingly, for obtaining desired heat releasing property and self-cooling property, it is at first necessary to coat a heat releasing film of 1 μm or more to the surface on the opposite side (thus, coating film is formed on the surface and the rearface) and it is necessary that the coating film contains heat releasing additives for forming the heat releasing coating film at least on the surface. Further, for ensuring a desired self-cooling property, it is necessary that the infrared ray emissivity at the surface is higher compared with that at the rearface to satisfy the formula (2) (to be described later) and it is necessary that the heat releasing property can satisfy at least the formula (3) (to be described later).

On the other hand, for the rearface, since a magnetic film of 3 to 50 μm is formed, it is not always necessary to further add heat releasing additives so long as a desired heat releasing property can be obtained. This is because an emissivity to some extent can be ensured only by the magnetic coating film. That is, while it is necessary that “coating film on the surface” should be a heat releasing coating film in order to ensure the excellent self-cooling property, “coating film on the rearface” is not necessarily a heat releasing coating film so long as the desired property can be obtained. Accordingly, the third coated material does not include “single side coated steel sheet” not applied with a coating film on the rearface of a metal sheet (since the infrared ray emissivity of a blank sheet with no coating film is about 0.04, no desired self-cooling property can be obtained). However, so long as the formula (2) can be satisfied, any coating film may be adopted. It will be apparent that more excellent heat releasing property can be obtained when heat releasing additives are added also to the magnetic coating film on the rearface.

With the purport as described above, the third coated material (III-1) is defined such that the heat releasing coating film on the surface contains the heat releasing additives, and the magnetic coating film at the rear face may further contain the heat releasing additives.

At first, “thickness of heat releasing coating film on the surface: 1 μm or more” in the embodiment described above is as has been described specifically in (II).

Further, the heat releasing additives to be used includes those heat releasing additives described in (II) (including carbon black and titanium oxide). Accordingly, unlike the second coated material described, the additives are not restricted to carbon black or titanium oxide with high emissivity but heat releasing additives such as Al flakes can also be used so long as they can satisfy (III-3) to be described later in the third coated material.

Specifically, the coating film on the rearface can be formed in the black metal sheet described previously by properly controlling the addition amount and the coating film thickness in accordance with the surface coating film. In a case of forming the coating film on the rearface by using the black additives, a desired self-cooling property can be ensured so long as the infrared ray emissivity of the surface coating film is properly controlled even in a case where the rearface scarcely has heat releasing property in a case of forming the coating film on the rearface by using the black additives.

Alternatively, a coating film with no addition of the additives at all in which the coating film thickness is controlled within a predetermined range (about 2.5 μm or more) can also be adopted. This is because a heat releasing property can be obtained to some extent only by the resin contained in the coating film.

Specifically, in a case of using a non-hydrophilic polyester resin as the coating film forming resin for instance, the coating film thickness may be controlled to about 2.5 μm or more.

(III-3)

Integrated emissivity of infrared rays (wavelength: 4.5 to 15.4 μm) when resin coated metal body is heated to 100° C. satisfies the following formula (2) and the following formula (3).
b≦0.9(a−0.05) formula (2)
(a−0.05)×(b−0.05)≧0.08 formula (3)

a: infrared ray integrated emissivity at the surface (on the side of atmospheric air as viewed from resin coated metal sheet)

b: infrared ray integrated emissivity at the rearface (inner side of the resin coated metal sheet)

Since the third coated material comprises the constitution described above and the temperature increase for the coated material per se can be suppressed, it can provide electronic equipment safe to users in a case of using the coated material as a casing of electronic equipment such that they feel “not hot” even when they touch the equipment. Further, since the coated material also has good heat releasing property, the electronic equipment component having both of the properties is extremely useful in further extending the application use.

At first, the index for self-cooling properties to be described.
b≦0.9(a−0.05) formula (2)

The formula (2) is defined as an index showing the heat releasing effect of transferring heat absorbed in the coated material to the atmospheric air by increasing the infrared ray emissivity at the surface compared with that at the rearface, which is useful as an index for “self-cooling property” for suppressing the rise of temperature of the coated material per se. The formula specifies a relation for the infrared ray emissivity at the surface and the rearface capable of ensuring a desired self-cooling property (0.5° C. or higher for ΔT to be described later) under the idea of “intending to suppress temperature rise of the coated article per se by applying coating film of increasing the infrared emissivity at the surface (on the side of atmospheric air) of the metal sheet compared with that at the rearface (inner side of the electronic equipment) of the metal sheet”.

In a case of using the coated material as the casing for the electronic equipment, when the infrared ray emissivity at the inner surface (rearface) of the casing is increased, the absorption amount for the infrared rays emitted from the heat source in the electronic equipment increases to rise the temperature of the coated material itself. On the other hand, when the emissivity at the outer surface of the casing (surface) is increased, the emission amount of infrared rays radiated from the coated material to the external air increases and the temperature of the coated article is lowered. According to the invention, the formulas described above has been determined as a result of various experiments based on the findings described above and, according to the invention, since the amount of heat radiated from the surface of the metal sheet is larger than the amount of heat absorbed (radiated) at the rearface of the metal sheet, temperature rise of the coated material itself can be suppressed efficiently.

As described above, a coated material in which coating films of different heat releasing properties are formed to the surface and the rearface of a metal sheet and the temperature rise of the coated material is suppressed while maintaining the level of the heat releasing property to some extent has not yet been known so far and it is considered to be novel.

Accordingly, in the third coated material, a better self-cooling property is obtained when the difference of the infrared ray emissivity between a and b is larger. Specifically, assuming the calculated value for the left side (0.9a−b) in the formula modified from the formula (2) (0.9a−b≧0.045) as Q value, it is preferred that the Q value is larger. It is 0.13 or more, 0.24 or more, 0.35 or more and 0.47 or more in the preferred order.
(a−0.05)×(b−0.05)≧0.08 formula (3)

The formula (3) specifies the index for the heat releasing property in the third coated material by the product of the infrared ray integrated emissivitys at the surface and the rearface, and it shows that the heat releasing property is more excellent as the calculated R value is larger for the left side [(a−0.05)×(b−0.05)).

The level for the heat releasing property in the third coated material (ΔT1≧1.5° C. when converted as ΔT1 to be described later) has a larger allowable range compared with the level for the second coated material (ΔT1≧2.6° C. described later). Improvement of the self-cooling property is a main subject to be solved in the third coated material and this is defined based on the knowledge that an embodiment with the level of the heat releasing property being somewhat lower compared with the second coated material can also be included so long as the subject can be attained.

(IV) Coated Material Further Excellent in Scratch Resistance and Fingerprint Resistance in the Coated Material in (I) Described Above (Fourth Coated Material)

The fourth coated material has a feature in satisfying (IV-1) or (IV-2) described above and also satisfying (IV-3) to (IV-4) described above in the first coated material thereby improving the scratch resistance and fingerprint resistance.

At first, the purport of defining (IV-1) and (IV-2) described above is to be described.

Since the fourth coated material is also required to have excellent microwave absorbability and workability as the premise thereof, it is necessary that the magnetic coating film is formed to at least the rearface and, specifically, it includes two embodiments, that is, an embodiment (IV-1) in which the magnetic coating film is formed only on the rearface and an embodiment (IV-2) in which the magnetic coating film is formed on the surface and the rearface.

On the other hand, with a view point for improving the scratch resistance and the fingerprint resistance in the black metal sheet it is necessary that at least the surface is to be black and that a resin coating film containing a predetermined white pigment and/or luster pigment is formed to the black surface. This is because the fourth coated material intends to apply the black metal sheet to the constituent material for electronic equipment components the resin coating film is coated on the surface required for preventing scratches or fingerprints to exhibit a hiding effect of controlling the color of the black metal sheet to such a color as making scratches or finger prints less conspicuous.

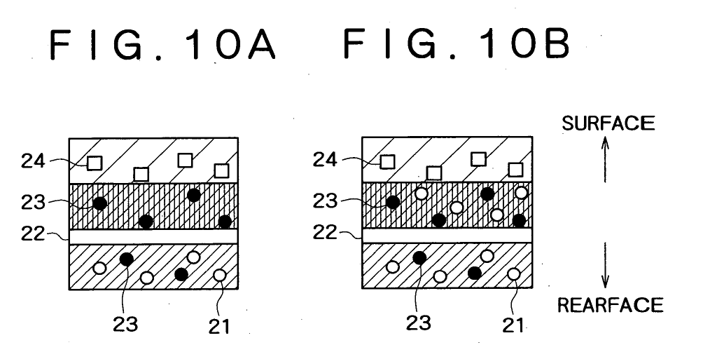

(IV-1) and (IV-2) Described above have been determined with such a view point and they are described with reference to FIG. 10.

(IV-1) Embodiment in Which a Magnetic Coating Film Satisfying the Factor Described Above is Formed Only at the Rearface of Metal Sheet [FIG. 10(a)]

In this case, the surface is in a two-layered constitution of a black coating film containing black additives and a resin coating film containing a white pigment and/or luster pigment [FIG. 10(a)]. With the two-layered coating film, desired scratch resistance and fingerprint resistance are provided. In FIG. 10, are shown a magnetic powder 21, a metal sheet 22, heat releasing additives 23, and white pigment/luster pigment 24.

On the other hand, the rearface is coated with the magnetic coating film described above and black additives may optionally be added to the magnetic coating film. In a case where the magnetic coating film on the rearface contains black additives, it may be further coated with a resin coating film containing a white pigment and/or luster pigment, by which excellent scratch resistance and fingerprint resistance can be ensured also on the side of the rearface. “Black coating film” and “resin coating film” described above are to be explained respectively.

For Black Coating Film

In the invention, “black coating film” means a coating film containing black additives. The black additives have no particular restriction so long as they can provide black color and include various black additives. As described above, the fourth coated material has a feature in coating a predetermined resin coating film containing a white pigment and/or luster pigment to one or both of the surfaces on the black side in the black metal sheet in order to improve the scratch resistance or the like in the black metal sheet and there is no intention for restricting the black coating film per se. The black additives used in the invention typically includes carbon black and, in addition, oxides, sulfides or carbides of Fe, Co, Ni, Cu, Mn, Mo, Ag, Sn, etc., and fine black metal powder can also be used.

Other factors in the black coating film, for example, kind of the black additives, kind of the resin added to the black coating film (base resin forming black coating film), and other ingredients that can be added (anti-rusting pigment, silica, crosslinker, etc.) are as described in (II) above.

Both the upper limit and the lower limit for the thickness of the black coating film having the constitution described above have no particular restriction in relation with the scratch resistance and the fingerprint resistance, but the lower limit is, preferably, 1 μm and, more preferably, 3 μm in view of corrosion resistance, workability or the like.

Further, the black coating film may also contain a conductive filler typically represented by Ni, by which excellent electrical conductivity can be ensured. However, in a case of adding a conductive filler to a black coating film, the lower limit for the film thickness is preferably controlled to 2 μm, by which both the corrosion resistance and the electrical conductivity can be obtained even for the chromium free coated material (as will be described later, the invention also includes chromium free coated materials). Accordingly, the lower limit is preferably 3 μm and, more preferably, 5 μm.

For the upper limit of the thickness of the black coating film, since the coated material according to the invention is particularly intended for application use to electronic equipment parts, and considering that improvement for the workability is also required in relation with the application use; and in view of prevention for the occurrence of cracking or peeling in the coating film upon bending processing, it is recommended to define the upper limit for the film thickness to 50 μm (45 μm, 40 μm, 35 μm, and 30 μm in the preferred order).

For providing good workability and also ensuring excellent electrical conductivity, it is recommended to add a conductive filler (to be described later) to the black coating film and the resin coating film. In this case, the thickness of the black coating film with addition of the conductive filler and the thickness of the resin coated film described above in total is preferably 13 μm or less (12 μm or less, 11 μm or less and 10 μm or less in the preferred order).

The metal sheet applied with the black coating film has no particular restriction and, for example, any of steel sheets such as cold rolled steel sheets and hot rolled steel sheets, various kinds of plated steel sheets such as electrically galvanized steel sheets (EG), galvanized molten steel sheets (GI), galvanized molten alloy steel sheets (GA), 5% Al—Zn plated steel sheets, 55% Al—Zn plated steel sheets or Al, stain steel sheets and known metal sheet can be applied.

The metal sheet may be applied with a surface treatment such as a chromate treatment or a phosphate treatment with an aim of improving the corrosion resistance and improving the adhesion of the coating film. On the other hand, a metal sheet applied with a non-chromate treatment may also be used in view of environmental pollution, and any of such embodiments is included within the scope of the invention. “Resin coating film” characterizing the fourth coated material is to be described specifically in (IV-3).

(IV-2) Embodiment in Which a Magnetic Coating Film Satisfying the Factor Described Above is Formed to the Surface and the Rearface of Metal Sheet [FIG. 10(b)]

In this embodiment, at least the magnetic coating film on the surface comprises a black magnetic coating film containing black additives and the black magnetic coating film on the surface is coated with a resin coating film containing a white pigment and/or a luster pigment, and the rearface may be coated with a resin coating film containing a white pigment and/or a luster pigment.

Among them, the factors regarding the black additives are as described in (IV-1).

(IV-3) Thickness and the Content of the Resin Coating Film Containing White Pigment and/or Luster Pigment

In the invention, the thickness of the resin coating film is set to 0.5 to 10 μm and the addition amount of the white pigment and/or luster pigment contained in the resin coating film is set to 1 to 25%. It has been confirmed by examples to be described later that no desired scratch resistance and fingerprint resistance can be obtained out of the range described above.

Before description to the definition above, the meaning of “resin coating film” and the kind of white pigment/luster pigment contained in the resin coating film in the invention are to be described.

As described previously, the resin coating film is coated to one or both of the surfaces on the side of black and contains white pigment and/or luster pigment. In this invention, the pigment described above is coated not for the primary purpose of addition (provision of esthetic property) but is coated with the purpose of addition quite different from the usual case, that is, improvement in the scratch resistance and the fingerprint resistance in the black metal sheet, and it has a most prominent feature in controlling the thickness of the resin coating film to 0.5 to 10 μm, controlling the addition amount of the white pigment and/or luster pigment contained in the resin coating film to 1 to 25% in total, and controlling the color (L value) for the entire resin coated metal sheet to 44.0 to 60.0.

As has been described above, the white pigment and the luster pigment are known as the pigment for providing glitter feeling (metallic color) or pearlescent feeling. However, the technical significance of the invention reside in the discovery that the effect of excellent scratch resistance and fingerprint resistance can be provided when the resin coating film containing the pigment can satisfy a predetermined range and can suppress not only scratches caused to the film but also scratches that could not be coped with by the existent transparent coating film (scratches per se generated in the edge or the like of steel sheets) and the technical idea of controlling the thickness and the addition amount of the pigment of the resin coating film to a predetermined range in relation with the scratch resistance and the fingerprint resistance is unique to the invention which has not been known at all so far.

By the way, JP-A Nos. 2002-363771, Hei 10-330657, and 2002-12795 merely disclose the modifying technique of the pigments with a view point of improving the esthetic property and they do not intend at all for the improvement of the scratch resistance and the fingerprint resistance. Accordingly, the resin coating film containing the luster pigment or the like is coated to a large thickness of about 15 μm or more (20 to 70 μm) in the documents, but it has been confirmed by the experiment that this cannot provide desired improving effect for the fingerprint resistance or the like (refer to examples to be described later).

Among the pigments used in the invention, the luster pigment reflects incident light to provide the coating film with esthetic property such as metallic feeling or pearlescent feeling (light interfering pattern) and can include, for example, metal powder such as aluminum powder, metal flake such as stainless steel flake, mica, micaceous iron oxide (MIO, flaky iron oxide), glass flake, and bronze pigment. Each of the luster pigments also includes those with coatings, for example, resin coated aluminum powder, silica coated aluminum powder, fluoro compound coated aluminum powder, hastelloyed coated glass flake, as well as those comprising mica as a main ingredient and coated at the surface with various kinds of metal oxides (for example, titanium oxide, iron oxide and tin oxide) or with various kinds of coloring pigments. For example, use of pearlescent pigments such as pearlescent mica (titanium oxide coated mica) (for example, Iriodin 103WII, Iriodin 121WII, Iriodin 111WII, etc. manufactured by Merck Japan) is recommended. They may be used alone or two or more of them may be used in combination.

Further, the white pigment used in the invention is a pigment added with an aim of providing the coating film with whiteness and can include, for example, titanium oxide [specifically JP301, JP603, JP806 and JRNC] manufactured by TAYCA CORPORATION, zinc white, zinc powder and chalk.

The white pigments and/or luster pigments may be used alone, or two or more of them may be used in combination. Accordingly, they can include those using two or more kinds of white pigments, using two or more of luster pigments and using at least one of white pigments and at least one of luster pigments, and all of such embodiments are included within the scope of the invention.

Among the pigments described above, particularly with a view point of improving the scratch resistance and the fingerprint resistance, white pigment and/or luster pigments containing oxide type additives are preferred and, among all, those containing titanium oxide are more preferred. Specifically, it is recommended to use those containing titanium oxide as the white pigment and titanium oxide as the luster pigment, for example, those comprising mica as the main ingredient the surface of which is coated with the metal oxide described above, particularly, titanium oxide coated mica (Iriodin 111WII, manufactured by Merck Japan).

Further, while the average particle size of the luster pigment/white pigment is different depending also on the shape of the pigment to be used and it is recommended to be 0.1 to 10 μm (preferably, 0.2-μm or more and 5 μm or less; further preferably, 3 μm or less) in the case of the granular shape; about 5 to 50 μm (preferably, 10 μm or more and 40 μm or less and, further preferably, 30 μm or less) in the case of flaky shape. When average particle size is less than each of the lower limit values, the hiding power for scratches and fingerprint by the addition of the pigment is worsened and it is necessary to increase the film thickness. However, when the film thickness is excessively large, it results in deterioration of the workability or the like (to be described later). On the other hand, when the average particle size exceeds each of the upper limit values, color unevenness tends to occur in the appearance of the coating film.

More specifically, it is preferred to set the average particle size to 0.1 μm or more and 0.4 μm or less in a case of titanium oxide and to set the average particle size to 5 μm or more and 50 μm or less and set the thickness to 0.2 μm or more and the 3 μm or less in a case of titanium oxide coated mica.

The average particle size of the pigment means the particle size (D50) obtained by measuring the particle size distribution of pigment particles after classification by a general particle size distribution meter and calculating the particle size for 50% accumulated value from the side of the small particle size based on the result of the measurement (D50). The particle size distribution can be measured by the intensity pattern of diffraction or scattering caused by irradiating light to particles and the particle size distribution meter can include, for example, microtrack 9220FRA or microtrack HRA manufactured by Nikkiso Co.

For the pigment satisfying the preferred average particle size described above, commercial products may also be used. For example, they include Iriodin 103WII (average particle size: 10 to 60 μm), Iriodin 121WII (average particle size: 5 to 25 μm), Iriodin 111WII (average particle size: 15 μm or less) manufactured by Merck Japan as the titanium oxide coated mica; JR301 (average particle size: 0.30 μm), JR603 (average particle size: 0.28 μm), JR806 (average particle size: 0.25 μm) and JRNC (average particle size: 0.37 μm) manufactured by TAYCA CORPORATION as titanium oxide.

Then, the factor characterizing the fourth coated material (film thickness of the resin coating film and addition amount of white pigment and/or luster pigment contained in the resin coating film) are to be described.

At first, the thickness of the resin coating film is set to 0.5 to 10 μm. When the film thickness is less than 0.5 μm, the effect of improving the scratch resistance and the fingerprint resistance is insufficient. It is preferably 1.5 μm or more and, more preferably, 2 μm or more. On the other hand, when the film thickness exceeds 10 μm, the workability is deteriorated. It is preferably 6 μm or less and, more preferably, 5 μm or less.

In a case of adding a conductive filler to the resin coating film with an aim of improving the electrical conductivity, it is recommended to set the upper limit for the resin coating film to 6 μm. This is because desired electrical conductivity cannot be obtained easily when it exceeds 6 μm. It is preferably 5 μm or less and, more preferably, 4 μm or less.

Further, the ratio of the white pigment and/or luster pigment in the entire resin coating film is from 1 to 25% in total. When it is less than 1%, addition amount of the pigment to the base coating material is insufficient making the effect of improving the scratch resistance and the fingerprint resistance insufficient. On the other hand, when it exceeds 25%, extendability of the coating film is worsened and cracking or, further, peeling of the coating film may possibly occur to the coating film when severe bending processing is applied. It is more, preferably, 2% or more and 20% or less and, more preferably, 3% or more and 15% or less.

The kind of the resin (base resin) added to the resin coating film has no particular restriction with a view point of the scratch resistance and the fingerprint resistance and acrylic resin, urethane resin, polyolefin resin, polyester resin, fluoro resin, silicon resin and mixed or modified resins derived therefrom can be used properly. In a case of using the coated material according to the invention particularly as a casing for electronic equipment, it is preferred that the base resin is a non-hydrophilic resin [preferably, those satisfying the angle of contact with water of 30° or more (more preferably 50° or more and, further preferably, 70° or more)] in view of the requirement for the improvement of the corrosion resistance and the workability in addition to the heat releasing property (to be described later). The resin capable of satisfying the non-hydrophilic property may vary depending on the extent of mixing or extent of modification and, for example, use of polyester resin, polyolefin resin, fluoro resin, silicon resin and mixed or modified resins derived therefrom, polyester resin or the modified polyester resin (thermosetting polyester resin or unsaturated polyester resin such as epoxy modified polyester resin and polyester resin in which a phenolic derivative is introduced to a skeleton) is recommended.

Further, an anti-rusting pigment or paint flow improver (silica particles or aluminum oxide) may also be added to the coating film within a range not deteriorating the effect of the invention.

Further, a crosslinker may be added to the coating film. The crosslinker used in the invention can include, for example, melamine compound and isocyanate compound and it is recommended to add one or more of them within a range from 0.5 to 20%.

(IV-4) Color of Resin Coated Metal Sheet of 44.0 to 60.0 as the L Value Measured by Color Difference Meter (SZS-Σ90) Manufactured by Nippon Denshoku Industries Co., Ltd.

The resin coated metal sheet according to the invention comprises the constitution as described above and the color of the resin coated metal sheet satisfies the L value of 44.0 to 60.0 measured by the color diffraction meter (SZS-Σ90) manufactured by Nippon Denshoku Industries Co., Ltd. Smaller L value means larger whiteness (black).

The reason why the L value is determined to the range described above is as below. As has been described above, the invention provides a resin coated metal sheet remarkably improved with the scratch resistance and the fingerprint resistance in the black metal sheet and, when the present inventors have studied on the relation between the color of the coating film and scratches and fingerprints, it has been found that scratches or fingerprints were conspicuous whitely in a case where the color of the coating film was black and, on the other hand, in a case where the color of the coating film is white, scratches or fingerprints were conspicuous in darkened state. Then, “for making the scratch or fingerprint on the coating film less conspicuous, the color of the coating film may be controlled within a predetermined range”. In the invention, the color (L value) of the resin coated metal sheet is defined within the range described above based on such knowledge.

When the L value is less than 44.0, scratches or fingerprints becomes conspicuous whitely and no desired scratch resistance and fingerprint resistance can be obtained. It is preferably 46 or more and, more preferably, 48 or more. When the L value exceeds 60.0, the scratches or fingerprints become conspicuous in a darkened state. It is preferably 56 or less and, more preferably, 52 or less.

In the coated material, in a case where it is desired to also enhance the electrical conductivity in addition to the scratch resistance and the fingerprint resistance, it is recommended to add, for example, a conductive filler to the black metal sheet and/or resin coating film. The conductive filler may be added only to the black metal sheet, only to the resin coating film, or to both of the black metal sheet and the resin coating film. When the conductive filler is added to both of them, excellent electrical conductivity can be obtained but, depending on the application use, the conductive filler may be added only to one surface, by which a predetermined electrical conductivity can also be ensured. Further, in a case of black metal sheets with both black surfaces, it may be added to at least one of them.

The conductive filler used in the invention can include elemental metals such as Ag, Zn, Fe, Ni and Cu; and metal compounds such as FeP. Among them, Ni is particularly preferred. While the shape has no particular restriction, it is recommended to use flaky shape in order to obtain more excellent electrical conductivity.

Further, the content of the conductive filler is 10 to 50% in total based on 100% (as solid content) of the coating film forming ingredients (means all ingredients forming the coating film including base resin such as polyester resin and, in addition, a crosslinker added optionally and, further, black additives and conductive filler and also additives added optionally). When it is less than 10%, no desired effect can be obtained. It is preferably 15% or more, more preferably, 20% or more and, further preferably, 35% or less. On the other hand, when the content of the conductive filler exceeds 50%, the workability is worsened. Particularly, in a case of application to a portion requiring high bendability as the coated metal sheet, it is 45% or less is recommended. It is more preferably, 40% or less and, further preferably, 35% or less.

Further, also in a case of using a metal sheet put to black primer treatment as the black metal sheet, good electrical conductivity can be ensured by forming a conductive filler-containing resin coating film satisfying the factor described above.

(V) Coated Material Further Excellent in Heat Releasing Property, Scratch Resistance and Fingerprint Resistance in the Coated Material (1) Described Above (Fifth Coated Material)

The fifth coated material has a feature in that the heat releasing property is improved by satisfying the following (V-1) or (V-2) (V-3) [identical with (II-3) described above], and the scratch resistance and the fingerprint resistance are improved by satisfying (V-4) and (V-5) [identical with (IV-3) and (IV-4) described above].

Among them, (II-3), (IV-3) and ((V-4) are as has been described above.

Then, the purport of defining (V-1) and (V-2) described above is to be described.

Since also the fifth coated material is required to have excellent microwave absorbability and workability as the premise thereof, it is necessary that the magnetic coating film is formed at least to the rearface and specifically it includes two embodiments, that is, an embodiment (V-1) in which the magnetic coating film is formed only to the rearface and an embodiment (V-2) in which the magnetic coating film is formed to the surface and the rearface. (V-1) The rearface of the metal sheet coated is with the magnetic coating film which is a heat releasing magnetic coating film having a heat releasing property and, when the heat releasing magnetic coating film contains black additives, a resin film containing white pigment and/or luster pigment may be coated,

the surface of the metal sheet a heat releasing coating film of 1 μm or more and a resin coating film containing white pigment and/or luster pigment,

(V-1-i) at least one of the heat releasing magnetic coating film on the rearface and the heat releasing coating film on the surface at least contains 1% or more of carbon black,

the surface not containing carbon black contains 10% or more of heat releasing additives other than carbon black; or

(V-1-ii) at least one of the heat releasing magnetic coating film on the rearface and the heat releasing coating film on the surface at least contains 30% or more of titanium oxide, and

the surface not containing titanium oxide contains 1% or more of heat releasing additives other than titanium oxide. (V-2) The magnetic coating film which is a heat releasing magnetic coating film having a heat releasing property is coated to both surfaces of the metal sheet,

(V-2-i) at least one surface of the heat releasing magnetic coating film contains 1% or more of carbon black,

the surface not containing carbon black contains 10% or more of heat releasing additives other than carbon black,

a resin coating film containing white pigment and/or luster pigment is coated at least to the heat releasing magnetic coating film on the surface; or

(V-2-ii) at least one surface of the heat releasing magnetic coating film contains 30% or more of titanium oxide,

the surface not containing titanium oxide contains 1% or more of heat releasing additives other than titanium oxide, and

a resin coating film containing white pigment and/or luster pigment is coated at least to the heat releasing magnetic coating film on the surface.

On the other hand, with a view point of improving the heat releasing property, it is necessary to satisfy the factor (II-3) defined for the second coated material described above.

Further, with a view point of improving the scratch resistance and the fingerprint resistance, it is necessary to satisfy the factors defined for the fourth coated material [(IV-3) and (IV-4)].

As described above, the fifth coated material is determined while considering the factor required for improving the microwave absorbability, the factor required for improving the heat releasing property and a factor required for improving the scratch resistance and the fingerprint resistance.

(VI) Coated Material Further Excellent in Heat Releasing Property, Self-Cooling Property, Scratch Resistance and Fingerprint Resistance in the Coated Material (I) Described Above (Sixth Coated Material)

The sixth coated material has a feature in that the heat releasing property and the self-cooling property are improved in the first coated material by satisfying the following (VI-1) or (VI-3) and satisfying (VI-3) and (VI-4) [identical with (III-3) and (III-4) described above], and the scratch resistance and the fingerprint resistance are improved by satisfying [(IV-5) and (IV-6) (described above) and (IV-3) and (IV-4)].

Since also the sixth coated material is required to have excellent microwave absorbability and workability, it is necessary that the magnetic coating film is formed at least to the rearface and, specifically, it includes two embodiments, that is, an embodiment (VI-1) in which the magnetic coating film is formed only on the rearface, and an embodiment (VI-2) in which the magnetic coating film is formed on the surface and the rearface.

(VI-1) The magnetic coating film is coated to the rearface of the metal sheet, the magnetic coating film may also contain black additives and, when the magnetic coating film contains the black additives, a resin coating film containing white pigment and/or luster pigment may be coated,

the surface of the metal sheet is coated with a black heat releasing coating film of 1 μm or more containing 1% or more of black additives and a resin coating containing white pigment and/or luster pigment; or

(VI-2) the magnetic coating film is coated to both surfaces of the metal sheet,

the magnetic coating film on the surface is a black heat releasing magnetic coating film of 1 μm or more containing 1% or more of black additives,

the magnetic coating film on the rearface may also contain 1% or more of heat releasing additives, and a resin coating film containing white pigment and/or luster pigment is coated at least to the black heat releasing magnetic coating film on the surface.

On the other hand, with a view point of improving the heat releasing property and the self-cooling property, it is necessary to satisfy the factors [(III-3) and (III-4)] described above defined for the third coated material.

Further, with a view point of improving the scratch resistance and the fingerprint resistance, it is necessary to satisfy the factors [identical with (IV-5) and (IV-6)] described above defined for the fourth coated material.

As described above, the sixth coated material has been determined while considering the factor required for improving the microwave absorbability, the factor required for improving the heat releasing property and the self-cooling property, and the factor required for improving the scratch resistance and the fingerprint resistance and, as a result, the factors described above have been determined. Details of them are as described above.

Then, a method of manufacturing the coated material according to the invention is to be described. The coated material according to the invention can be manufactured by coating and drying a coating material containing the ingredients described above by a known coating method to the surface of the metal sheet. While the coating method has no particular restriction, it can include, for example, a method of applying a coating material to the surface of an elongate metal strip cleaned at the surface and applied with a coating pretreatment if necessary (for example, phosphate treatment or chromate treatment) by using a roll coater method, spray method or curtain flow coater method and then passing the same through a hot blow drying furnace for drying. The roll coater method while collectively considering the uniformness of the coating film thickness, processing cost and coating efficiency.

In a case of using the resin coated metal sheet for the metal sheet, a phosphate treatment or chromate treatment may be applied with an aim of improving the adhesion with the resin coating film or corrosion resistance. However, for the chromate treated material, it is preferred to suppress the Cr deposition amount during chromate treatment to 35 mg/m² or less with a view point of chromate leaching property during use of the resin coated material. This is because leaching of chromium from the underlying chromate treated layer can be suppressed within the range described above. Further, in the existent chromate treated materials, while the water proof adhesion of the top coat coating disposed optionally tends to be deteriorated under moistened circumstance along with leaching of hexavalent chromium, since such leaching is suppressed in the metal sheet described above, water proof adhesion of the top coating film is not worsened.

Alternatively, when the chromium-free primer treatment described above is applied, for example, by a roll coater method, spray method or dipping method, a non-chromate type coated material can be obtained.

Further, the invention also includes electronic equipment parts incorporating a heat generation body in a closed space in which the outer wall of the electronic equipment part is entirely or partially constituted with the coated material for use in electronic equipment components. The electronic equipment parts can include, for example, information recording products such as CD, LD, DVD, CD-ROM, CD-RAM, PD and LCD; products concerned with electric, electronic and communication fields such as personal computers, car navigators, car AV; AV equipment such as projectors, television sets, video equipment, and game machines; copying machines such as copiers or printers; box covers for power supplies such as external units of air conditioners, control box covers, automatic bending machines and refrigerators.

### EXAMPLE

The present invention is to be described more specifically by way of examples but the invention is no way restricted to the following examples and all modifications within a range not departing the gist of the invention are included in the invention.

### Example 1

### Study on Microwave Absorbability, Workability, Heat Releasing Property, Electrical Conductivity and Workability (1)

In this example, study was conducted on the microwave absorbability, workability, heat releasing property, electrical conductivity and workability when various magnetic powders, electrically conductive additive (Ni) and black addition (carbon black) shown in Table 1 and Table 2 were added to the surface and the rearface of a metal sheet.

Specifically, electrically galvanized steel sheets (thickness: 0.8 mm; Zn deposition amount for each of surface and rearface: 20 g/m²) were used as the blank steel sheet, a magnetic coating film (with addition of various kinds of additives shown in Tables 1 and 2, (magnetic powder, electrically conductive additive, carbon black) was added (base resin: epoxy modified polyester, cross linker: isocyanate) on both surfaces (surface and rearface) (120×150 mm), and the characteristics such as microwave absorbability, electrical conductivity, workability and heat releasing property in each of coated metal sheets thus obtained were evaluated. Each of the characteristics was evaluated respectively in accordance with the following evaluation methods (1) to (4).

(1) Evaluation Method for Microwave Absorbability

<Method A>

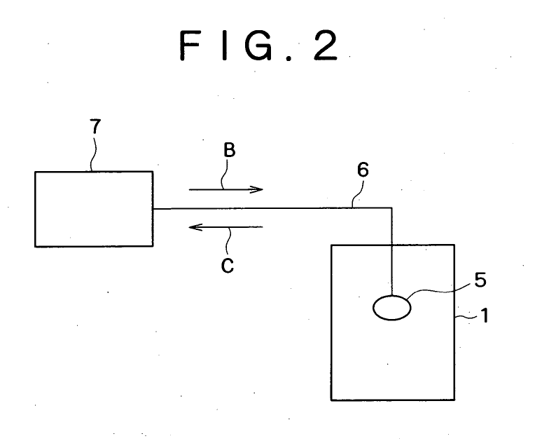

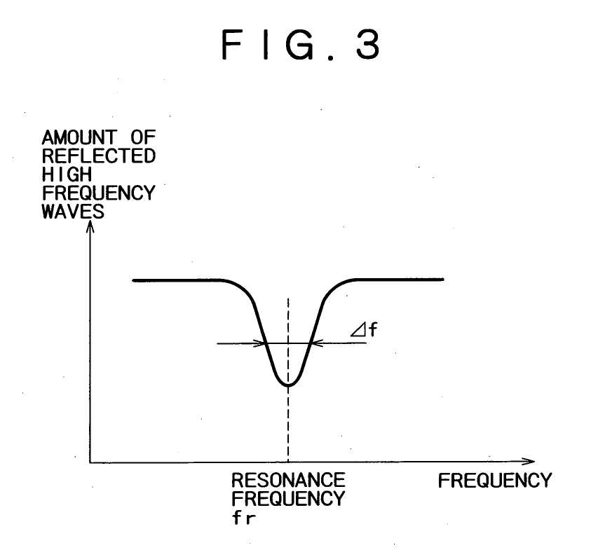

FIG. 2 is a view for explaining the method of evaluating the microwave absorbing performance in a coated metal sheet. A high frequency wave loop antenna 5 is placed in a rectangular casing 1 and coupled magnetically. The high frequency wave loop antenna 5 is connected by way of a connector (not illustrated) to one end of a coaxial cable 6, and the other end of the coaxial cable 6 is connected with a network analyzer 7. The network analyzer 7 is adapted to generate microwaves while sweeping frequency and imputing them by way of the coaxial capable 6 and the high frequency wave loop antenna 5 into the casing 1 (high frequency wave input:arrow B). Since inputted microwaves are accumulated at the resonance frequency of the casing 1, characteristics of decreasing the amount of reflection are observed (refer to FIG. 3). Then, reflected high frequency waves are inputted as an observed value to the network analyzer 7 (reflected high frequency wave: arrow C).

When the Q value in the casing 1 determined according to the following formula (1) is measured, the magnitude of energy accumulated in the casing 1 can be determined. The Q value determined according to the following formula (1) is calculated based on the frequency difference Δf and the resonance frequency fr determined based on the conditions that the admittance orbit can satisfy (“Masamitsu Nakajima, Morikita Electrical Engineering Series 3, Microwave Engineering Foundation and Principle”, published from Morikita Shuppan Co., Ltd. pp 159 to 163).
Q value=fr/Δf (1)

As the Q value determined from the formula (1) is smaller, the energy accumulated in the casing 1 decreases. Accordingly, as the Q value is smaller, the microwave level reflected to the outside from the casing 1 is also lowered. Actual measurement was conducted by using the casing 1 sized 106×156×200 (mm).

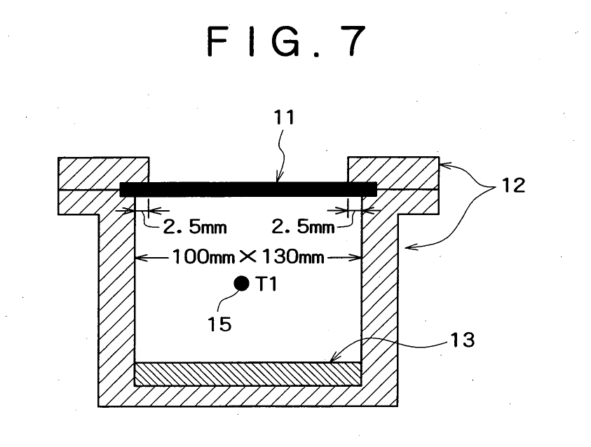

FIG. 4 schematically shows the state. The drawing illustrates the electromagnetic field distribution in a resonance mode at the lowest frequency of: Ez=0, TE011 in which E represents a high frequency magnetic field and F represents a electric field respectively, respectively. Ez represents electronic field intensity in the direction z and TE011 shows the state of the electromagnetic field distribution in the resonance mode. TE means that electric field, when waves propagate in the direction z, present in the lateral direction thereof. Suffix “011” means that an intensity distribution of the electric field is present by one in the direction y and the direction z relative to the direction x, y, z while the electric field intensity distribution does not change in the direction x (for example, referred to the document described, pp 141 to 144).

Further, the electromagnetic field distribution shown in FIG. 4 can be represented by the following formulae.
Hz=H011·cos(ky·y)sin(kz·z)
Hy=(−kz·ky/kc²)·H011·sin(ky·y)·cos(kz·z)
Ex=(−jωμky/kc²)·H011·sin(ky·y)·sin(kz·z)

wherein ky=π/b, kz=π/c, kc=ky. b, c represents each the length in the direction y, z of a rectangular (casing 1) in FIG. 4. j represents an imaginary number, ω represents each frequency and R represents permeability of air, respectively.

The resonance frequency of the resonance mode is about 1220 MHz. Upon evaluation, assuming the reference in a case of using stainless steel sheets for six surfaces of a rectangular as Q0 value (result of measurement: 1740) and the Q value measured by changing one bottom surface (surface of 106 mm×156 mm) and two lateral surfaces of 106 mm×200 mm), i.e., three surfaces in total with trially prepared test sample steel sheets as Q1 value, and the ratio Q1/Q0 (attenuation ratio) was calculated to confirm microwave absorbing effect of the test sample.

In this example, those with the ratio Q1/Q0 (attenuation ratio) calculated in accordance with the method described above of 0.97 or less are evaluated as “example of the invention”.

<Method B>

Since the circumstance is different from the circumstance of actually using the microwave absorbing steel sheets in the method A described above, improvement was made in the method B such that evaluation can be conducted in a state closer to the actual working circumstance. A microwave absorbing steel sheet was appended to a portion of a casing of the test apparatus in the method A, whereas the casing itself can be evaluated as the microwave absorbing steel sheet in the method B.

That is, in the method A, the ratio of the area of the sample steel sheet is about 30% for the entire surface area at the inner surface, and the microwave absorbing effect by the sample steel sheet is small and is less recognizable. Then, a casing in which the sample steel sheet can cover about 100%, that is, over the entire inner surface of the casing (240×180×90 mm) was prepared. The resonance frequency of this casing is about 1 GHz. The casing 1 comprises a frame made of SUS, to which six sheets each comprising a sample steel sheet were appended on the lateral surface, while appending SUS sheet on upper and lower surfaces) and the value Q was measured. With the constitution described above, the ratio for the area of the sample steel sheet on the inner surface of the casing can be increased to about 100%. Since screws for attaching the sheet to the casing are arranged each at 20 to 40 mm pitch to reduce the ohmic resistance, a number of screw setting is required. The screw setting is torque controlled to improve the reproducibility for the measurement of the Q value. Then, the microwave absorbability was calculated according to the following formula.

(Microwave absorbability (dB) of sample A)=10* log₁₀ (EG/A),

EG: Q value of electrically galvanized steel sheet,

A: Q value of sample A

As dB is higher, the microwave absorbability is superior.

While the microwave absorbing steel sheet is used for electronic equipment casing, it is not used being attached to a portion for the surface of the casing as in the method A but it is used just for the casing itself, so that the method B is closer to an actual case. Further, in the method A, since the ratio of the microwave absorbing steel sheet to the casing area is small, the microwave absorbing effect cannot be obtained smoothly. In the method B, since a most portion of the casing area is occupied by the microwave absorbent steel sheet, evaluation can be conducted in a state closer to actual working circumstance and, as a result, the microwave absorbing effect is more clearer in the method B while the effect cannot be recognized easily as a distinct difference by the sample in the method A.

(2) Electrical Conductivity Evaluation Method

Using “Loresta-EP” manufactured by MITSUBISHI CHEMICAL CORPORATION as a electrical conductivity measuring apparatus and a four-needle probe (ESP probe: MCP *TPO8P) manufactured by MITSUBISHI CHEMICAL CORPORATION and the resistivity of the samples was measured. In the invention, those with results of ⊚ or ◯ based on the following evaluation standards are evaluated as “Examples of the Invention”.

[Standard Evaluation]

⊚: less than 0.1 mm Ω
◯: 0.1 to 1 Ω or less
Δ: 1 to 10⁶ Ω or less
×: 10⁶ or more
   (3) Workability Evaluation Method

A bending resistant test (180° close adhesion bending test) according to JIS K 5400 was conducted to visually observe the extent of crack in the film after the test and the peeling in the film after taping and they were evaluated according to the following standards. In this invention, those with results of ⊚, ◯ or Δ based on the following evaluation standards were evaluated as “Example of the invention”.

[Evaluation Standard]

⊚: no absorbability
◯: slight cracking and peeling
Δ: cracking and peeling
×: cracking and peeling occurred for entire surface.
   (4) Heat Releasing Property Evaluation Method

With an aim of examining the heat releasing property at the surface and the rearface, the integrated dissipation rate of infrared rays at the surface and the rearface (wavelength: 4.5 to 15.4 μm) was measured in accordance with the method described above and the heat releasing property represented by ΔT1 was evaluated in accordance with the following method.

[Measurement for ΔT1 (Evaluation for Heat Releasing Property)]

ΔT1 defines the index how the internal temperature of the electronic equipment can be lowered in a case of using the coated material according to the invention compared with a case of using a metal sheet (blank sheet not coated with black coating film/not applied with black primer treatment). In the invention, a unique heat releasing property evaluation apparatus shown in FIG. 4 was used as the apparatus for measuring ΔT1. The device of FIG. 4 is extremely useful as a device capable of evaluating the heat releasing property at an atmospheric temperature assumed in the application use for electronic equipment, etc. (generally at 50 to 70° C., about 100° C. at the highest while the atmospheric temperature is different depending on the kind of the electronic equipment components), by which the heat releasing effect at a practical level simulating the application use for electronic equipment can be evaluated exactly.

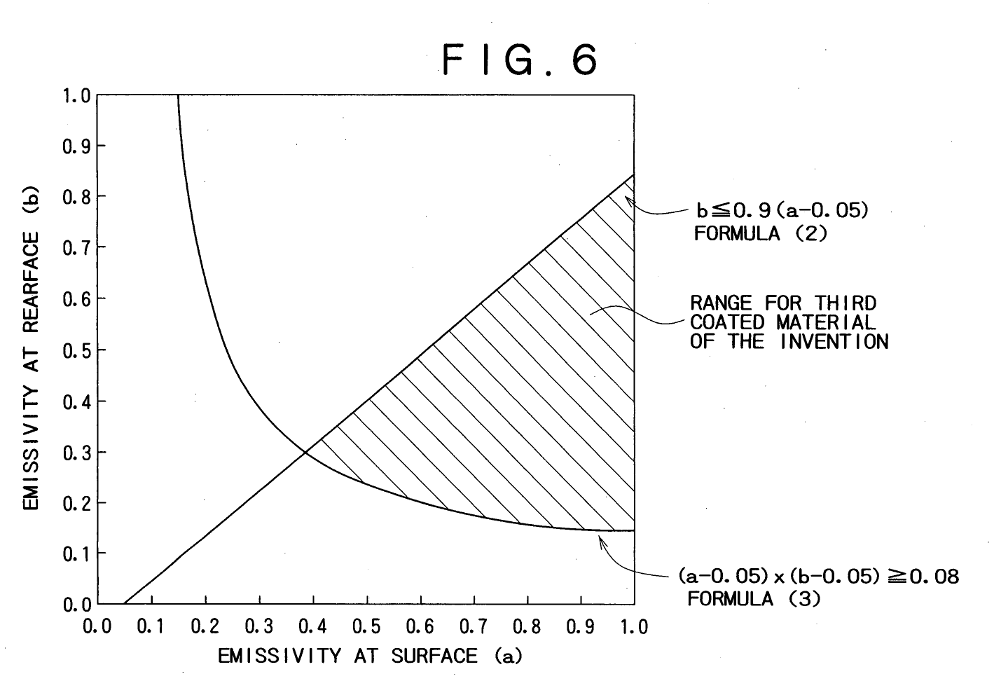

Especially FIG. 7 shows a rectangular apparatus with an inner space of 100 mm (length)×130 mm (width)×100 (height). In FIG. 7, are shown a specimen 11 (test specimen with measuring area of 100×130 mm), a heat insulation material 12, a heat generation body 13 [1300 mm² of bottom area, the length for the longest line drawable within the area of the heat generation body (length for the diagonal line FIG. 7) of 164 mm], and a temperature measuring device 15.

As the heat generation body 13, a silicon rubber heater is used on which an aluminum sheet (infrared ray emissivity of 0.1 or less) is adhered closely. Further, thermocouple as a temperature measuring device 15 is fixed at a T1 position in FIG. 7 [central part in the inner space (3 to 500 mm above the heat generating body)]. With an aim of excluding the effect of heat radiation from the heat generating body, the lower portion of the thermocouple is covered. Further, since the atmospheric temperature in the box changes depending on the kind and the mode of using the heat insulative material 12 (which has an effect also on the heat releasing property), a metal sheet with an infrared ray emissivity of 0.03 to 0.06 [for example, electrically galvanized steel sheet (for example, JIS SECC)] is used and the way of appending the heat insulative material is adjusted such that the atmospheric temperature (temperature at the absolute value) at the potion Ti is within a range of about 73 to 74° C. by the method to be described later. In addition, other factors giving effects on the heat releasing property (for example, fixing method for test samples) are also controlled such that the atmospheric temperature (absolute temperature) at the Ti position is within a range about 73 to 74° C.

Then, the method of evaluating the heat releasing property (ΔT1) by using the apparatus described above is to be described.

Upon measurement, the measuring condition is controlled to a temperature of 23° C. and a relative humidity of 60% within an aim of eliminating the scattering of data by external conditions (wind blow or the like).

At first, each of test materials is placed and the hot sheet 13 is heated to 140° C. by turning on the power source. After confirming that the temperature of the hot sheet is stabilized to 140° C. and the temperature at the T1 is at 60° C. or higher, the test material is once detached. At the instance where the box internal temperature lowers 50° C., the test material is set again and the in-casing temperature 90 min after the setting is measured respectively. Then, the temperature difference (Δ1) between the temperature of using the specimen and the temperature of using not-coated original blacken sheet without applying coating film is calculated.

ΔT1 was measured five times for each of the specimens and an average value for the data at three points excluding the upper limit and the lower limit was defined as ΔT1 in the invention.

The thus calculated ΔT1 shows that the heat releasing property is more excellent as the value is lager and it was evaluated relatively according to the following standards in this example. In the second coated material according to the invention, coated materials for ⊚ and ● are evaluated as “exhibiting excellent dissipating property in coated material”.
⊚: 3.5≦ΔT1
●: 2.7≦ΔT1<3.5
◯: 1.5≦ΔT1<2.7
Δ: 1.0≦ΔT1<1.5
∴: ΔT1<1.0

The results are shown together with the constitution of the magnetic coating film in the following Tables 1 and 2.

TABLE 1

| | | | Electrically | | | | | | | | | | | | |
|---|---|---|---|---|---|---|---|---|---|---|---|---|---|---|---|
| | Magnetic | | conductive | | Carbon | | Microwave | | | | | | | Heat | |
| | powder | | additive | | black | | absorbability | | | | | | | releasing- | |
| | | Addi- | | Addi- | Addi- | | Method A | | | | | | | property | |
| | | tion | | tion | tion | Film | | Atten- | | | | Emissivity | | | Rela- |
| | | amount | | amount | amount | thick- | | uation | | | | Surface a | | | tive |
| | | (mass | | (mass | (mass | ness | | ratio | Method B | Fabric- | Conduc- | (=rear − | | ΔT1 | evalu- |
| No. | Kind | %) | Kind | %) | %) | (μm) | Q₁ | (Q₁/Q₀) | (dB) | ability | tivity | face b) | a × b | (° C.) | ation |
| 1 | Ni—Zn | 20 | — | 0 | 0 | 10 | 1680 | 0.966 | 0.93 | ⊚ | X | 0.58 | 0.34 | 1.0 | X |
| 2 | soft | 30 | — | 0 | 0 | 10 | 1650 | 0.948 | 1.08 | ⊚ | X | 0.57 | 0.32 | 1.0 | X |
| 3 | magnetic | 40 | — | 0 | 0 | 10 | 1520 | 0.931 | 1.14 | ◯ | X | 0.57 | 0.32 | 1.0 | X |
| 4 | ferrite | 50 | — | 0 | 0 | 10 | 1580 | 0.908 | 1.36 | ◯ | X | 0.57 | 0.32 | 1.0 | X |
| 5 | | 60 | — | 0 | 0 | 10 | 1540 | 0.885 | 1.59 | Δ | X | 0.57 | 0.32 | 1.0 | X |
| 6 | | 25 | Ni | 30 | 0 | 10 | 1640 | 0.943 | 1.03 | Δ | ⊚ | 0.56 | 0.31 | 1.0 | X |
| 7 | | 25 | Ni | 30 | 10 | 10 | 1640 | 0.943 | 1.05 | Δ | ⊚ | 0.83 | 0.69 | 3.8 | ⊚ |
| 8 | | 25 | Ni | 30 | 10 | 13 | 1610 | 0.925 | 1.26 | Δ | ⊚ | 0.86 | 0.74 | 4.1 | ⊚ |
| 9 | | 25 | Ni | 30 | 10 | 30 | 1480 | 0.851 | 3.12 | Δ | X | 0.88 | 0.77 | 4.1 | ⊚ |
| 10 | | 25 | Ni | 25 | 10 | 10 | 1640 | 0.943 | 1.03 | ◯ | ⊚ | 0.84 | 0.71 | 3.9 | ⊚ |
| 11 | | 50 | — | 0 | 0 | 2 | 1720 | 0.989 | 0.45 | X | X | 0.21 | 0.04 | 0.5 | X |
| 12 | | 50 | — | 0 | 0 | 60 | 1070 | 0.615 | 7.21 | X | X | 0.7 | 0.49 | 3.0 | ● |
| 13 | | 10 | — | 0 | 0 | 10 | 1730 | 0.994 | 0.46 | ⊚ | X | 0.58 | 0.34 | 1.0 | X |
| 14 | | 70 | — | 0 | 0 | 10 | 1500 | 0.862 | 1.72 | X | X | 0.55 | 0.30 | 1.0 | X |

TABLE 2

| | | | Electrically | | | | | | | | | | | | |
|---|---|---|---|---|---|---|---|---|---|---|---|---|---|---|---|
| | Magnetic | | conductive | | Carbon | | Microwave | | | | | | | Heat | |
| | powder | | additive | | black | | absorbability | | | | | | | releasing- | |
| | | Addi- | | Addi- | Addi- | | Method A | | | | | | | property | |
| | | tion | | tion | tion | Film | | Atten- | | | | Emissivity | | | Rela- |
| | | amount | | amount | amount | thick- | | uation | | | | Surface a | | | tive |
| | | (mass | | (mass | (mass | ness | | ratio | Method B | Fabric- | Conduc- | (=rear − | | ΔT1 | evalu- |
| No. | Kind | %) | Kind | %) | %) | (μm) | Q₁ | (Q₁/Q₀) | (dB) | ability | tivity | face b) | a × b | (° C.) | ation |
| 15 | Perm- | 20 | — | 0 | 0 | 10 | 1680 | 0.966 | 0.63 | ⊚ | ◯ | 0.57 | 0.32 | 1.0 | X |
| 16 | alloy | 30 | — | 0 | 0 | 10 | 1660 | 0.954 | 0.75 | ⊚ | ⊚ | 0.56 | 0.31 | 1.0 | X |
| 17 | (78 | 40 | — | 0 | 0 | 10 | 1620 | 0.931 | 0.89 | ◯ | ⊚ | 0.57 | 0.32 | 1.0 | X |
| 18 | mass | 50 | — | 0 | 0 | 10 | 1580 | 0.908 | 1.11 | ◯ | ⊚ | 0.56 | 0.31 | 1.0 | X |
| 19 | % Ni) | 60 | — | 0 | 0 | 10 | 1530 | 0.879 | 1.25 | Δ | ⊚ | 0.55 | 0.30 | 1.0 | X |
| 20 | | 20 | Ni | 20 | 0 | 10 | 1670 | 0.960 | 0.65 | ◯ | ⊚ | 0.56 | 0.31 | 1.0 | X |
| 21 | | 30 | Ni | 10 | 0 | 10 | 1650 | 0.948 | 0.74 | ◯ | ⊚ | 0.57 | 0.32 | 0.5 | X |
| 22 | | 30 | Ni | 10 | 10 | 10 | 1640 | 0.943 | 0.71 | ◯ | ⊚ | 0.83 | 0.69 | 3.8 | ⊚ |
| 23 | | 30 | — | 0 | 10 | 10 | 1640 | 0.943 | 0.76 | ⊚ | ⊚ | 0.83 | 0.69 | 3.8 | ⊚ |
| 24 | | 40 | — | 0 | 10 | 10 | 1620 | 0.931 | 0.90 | ◯ | ⊚ | 0.83 | 0.69 | 3.8 | ⊚ |
| 25 | | 10 | — | 0 | 0 | 10 | 1730 | 0.994 | 0.35 | ⊚ | X | 0.58 | 0.34 | 1.0 | X |
| 26 | | 70 | — | 0 | 0 | 10 | 1470 | 0.845 | 1.32 | X | ⊚ | 0.55 | 0.30 | 1.0 | ⊚ |
| 27 | Sen- | 40 | — | 0 | 10 | 10 | 1610 | 0.925 | 0.86 | ◯ | ⊚ | 0.84 | 0.71 | 3.9 | ⊚ |
| | dust | | | | | | | | | | | | | | |
| 28 | Perm- | 20 + | — | 0 | 10 | 10 | — | — | 1.29 | ◯ | ◯ | 0.84 | 0.71 | 3.9 | ⊚ |
| | alloy + | 12.5 | | | | | | | | | | | | | |
| | fer- | | | | | | | | | | | | | | |
| | rite | | | | | | | | | | | | | | |

From the tables described above, it can be considered as below.

At first, each of the specimens (Nos. 1 to 10, 15 to 24, 27) satisfying the range of the invention for the factors regarding the magnetic coating film (content of magnetic powder and thickness of magnetic coating film) provide good characteristics in view of the microwave absorbability and the workability.

Additionally explaining the microwave absorbability, while the attenuation ratio is about 3 to 15% in the specimens, since the inside of the device used for the measurement has a simple structure compared with that of an actual electronic equipment, it is supposed that in a case of using the coated steel sheet according to the invention to the actual electronic equipment, the multiple reflection increases further and leaked microwaves can be attenuated greatly. Further, since it can be expected for the attenuation of leaked microwaves from the by using the coated steel sheet of the invention to the main body of an electronic equipment or to the cover or casing, etc. for the unit in the main body unit due to the inner surface coating film of the steel sheet applied to the unit and, further, it can be expected for the attenuation of the microwaves leaked from the unit by the multiple reflection caused by the outer surface film of the coated steel sheet applied to the unit and the inner surface film of the coated steel sheet applied to the main body, it is expected that microwaves leaked from the main body can be attenuated greatly.

Particularly, among the specimens described above, examples (Nos. 15 to 24) using a magnetic metal powder (permalloy) as the magnetic powder can provide excellent electrical conductivity irrespective electrical conductivity irrespective of the absence or presence of conductive additives. Further, examples (Nos. 1 to 10) of using Ni—Zn soft magnetic ferrite not having electrical conductivity as the magnetic powder do not show good electrical conductivity by the magnetic powder alone (Nos. 1 to 5) but when an appropriate amount of the electrically conductive additive is added to the magnetic coating film, excellent electrical conductivity is provided (Nos. 6 to 10).

Further, those (Nos. 7 to 10, 22 to 24, 27) with appropriate addition of carbon black in relation with the coating film thickness can provide excellent heat resistant property.

On the contrary, each of the specimens which lacks in any of the factors defined according to the invention has the following disadvantages respectively.

At first, No. 11 is an example having a thickness of the magnetic coating film of 2 μm which is below the range of the invention, and has good microwave absorbability, but is poor in the workability.

On the other-hand, No. 12 is an example having a thickness of the magnetic coating film of 60 μm which exceeds the range of the invention in which both the microwave absorbability and the workability are deteriorated. In No. 12, while carbon as the heat releasing additives is not added, the evaluation for the heat releasing property is Δ which is higher compared with an example with no addition of carbon black (evaluation for heat releasing property ×), because the thickness of the resin film is increased as 60 μm.

Further, Nos. 13 and 25 are examples with the addition amount of the magnetic powder of 10% which is below the range of the invention and while the workability is good the microwave absorbability is deteriorated.

On the other hand, Nos. 14 and 26 are examples with the addition amount of magnetic powder of 70% which exceeds the range of the invention and while the microwave absorbency is good, the workability is worsened.

### Example 2

### Study on Microwave Absorbability, Workability, Heat Releasing Property and Self-Cooling Property (2)

In this example, the microwave absorbability, workability, heat releasing property and electrical conductivity were examined when adding various magnetic powders (A to E), heat releasing additives (H to J) and, optionally, electrically conductive additive [Ni (average particle size 15 to 20 μm)] to a rearface or both surfaces of a metal sheet.

In the table, details for each of additives are as shown below.

[Magnetic Powder]

A: Ni—Zn Based Soft Magnetic Ferrite

[BSN-125 manufactured by TODA KOGYO CORP., average particle size 13.0 μm]

B: Nn—Zn Based Soft Magnetic Ferrite

[KNS-415 manufactured by TODA KOGYO CORP., average particle size 9.9 μm]

C: Permalloy (78% Ni)

[SFR-PC 78, manufactured by Nippon Atomized Metal Powders Corporation average particle size of 5.7 μm]

D: Permalloy (45% Ni)

[SFR-PB 45, manufactured by Nippon Atomized Metal Powders Corporation average particle size of 5.8 μm]

E: Sendust

[SFR-FeSiAl (84.5-10-5.5), manufactured by Nippon Atomized Kako Co. average particle size of 6.9 μm]

[Heat Releasing Additives]

H: Carbon Black

[“MITSUBISHI Carbon Black”, manufactured by MITSUBISHI CHEMICAL CORPORATION, average particle-size of 25 nm]

I: Titanium Dioxide [JR 301, Manufactured by TAYCA CORPORATION, Average Particle Size of 0.3 μm]

J: Al Flake

[LB584, manufactured by SHOWA ALUMINUM POWDER K.K., average particle size of: 25 μm]

Specifically, electrically galvanized steel sheets (sheet thickness: 0.8 mm; Zn deposition amount each on surface and rearface: 20 g/m²) were used as blank steel sheets, and magnetic coating films each formed with addition of various kinds of additives shown in Table 3 (magnetic powder, heat releasing additives and electrically conductive additive) (base resin: epoxy modified polyester, cross linker: isocyanate) were formed to one surface (surface) or both surfaces (surface and rearface) (120×150 mm), and the microwave absorbability, workability and electrical conductivity in each of the obtained coated metal sheets were evaluated in the same manner as in Example 1 and, with an aim of examining the heat releasing property at the surface and the rearface, the integrated emissivity of infrared rays (wavelength: 4.5 to 15.4 μm), and the heat releasing property shown by ΔT1 for the surface and the rearface were examined by the method described in Example 1, and the self-cooling property shown by ΔT2 was evaluated by the following method (only to a partial example for the self-cooling property).

[Measurement for ΔT2 (Evaluation for Self-Cooling Property)]

ΔT2(=T2B−T2A) defines an index how the temperature elevation in the coated material itself can be suppressed (self-cooling property) during operation of an electronic equipment in a case of using the coated material according to the invention compared with a case of using a metal sheet (blank sheet left as it is without coating the coating film) and it was calculated by using a unique heat releasing evaluating apparatus shown in FIG. 7.

In the formula, T2A represents the temperature of the coated material when Nos. 1 to 7 Table 3 were measured as the specimen and T2B represents the temperature when a metal sheets not covered with the coating film was used as the specimen respectively. Measurement for ΔT2 was conducted five times for each of the test specimens and the average value for data at three points except for the upper limit and the lower limit was defined as ΔT2 in the invention and it was evaluated relatively according the following standards.

Larger ΔT2 means more excellent self-cooling property and, for the third coated material according to the invention, coated materials with ⊚ and ◯ are evaluated as “providing excellent self-cooling property”.
⊚: 1.5≦ΔT2
◯: 0.5≦ΔT2<1.5
×: ≦ΔT2<0.5

The emissivity at the surface and the rearface and ΔT1 data in the coated material are as shown in Table 3 described above and for the third coated material according to the invention, coated materials with ΔT1 of ⊚, ● and ◯ are evaluated as “providing excellent heat releasing property in the coated material”. By the way, for the second coated material described above, the coated materials with ΔT1 of ⊚ and ● are evaluated as “providing excellent heat releasing property in the coated material”. The evaluation standard regarding the heat releasing property (ΔT1) is different as described above because the third coated material also includes an embodiment in which the heat releasing property is somewhat lower compared with that of the second coated material.

Table 4 shows the results. In Table 4, the result for microwave absorbability and workability are omitted.

TABLE 3

| | Surface | | | | | | Rearface | | | | | |
|---|---|---|---|---|---|---|---|---|---|---|---|---|
| | | Lower layer | | | | | | Lower layer | | | | |
| | | | Kind of | | | | | | Kind of | | | |
| | | Kind of | heat | | Upper layer | | | Kind of | heat | | Upper layer | |
| | | magnetic | releasing | Film | Kind of | Film | | magnetic | releasing | Film | Kind of | Film |
| | Emissivity | powder | additives | thickness | pigment | thickness | Emissivity | powder | additive | thickness | pigment | thickness |
| No. | a | (mass %) | (mass %) | μm | (mass %) | μm | b | (mass %) | (mass %) | μm | (mass %) | μm |
| 1 | 0.70 | — | H (14)* | 2 | — | — | 0.63 | A (30) | H (10)* | 2.5 | — | — |
| 2 | 0.72 | — | H (7)* | 5 | — | — | 0.83 | C (40) | H (10) | 9 | — | — |
| 3 | 0.86 | — | H (12) | 10 | — | — | 0.80 | A (25) | H (7) | 12 | — | — |
| 4 | 0.87 | — | H (13) | 10 | — | — | 0.35 | C (40) | H (1) | 1.8 | — | — |
| 5 | 0.65 | — | I (60)* | 8 | — | — | 0.82 | E (40) | H (12) | 9 | — | — |
| 6 | 0.70 | — | I (50) | 12 | — | — | 0.38 | B (25) | I (20)** | 3 | — | — |
| 7 | 0.84 | — | I (60) | 40 | — | — | 0.55 | B (30) | I (50) | 5 | — | — |
| 8 | 0.85 | — | I (60) | 50 | — | — | 0.53 | D (40) | I (50) | 4 | — | — |
| 9 | 0.52 | — | J (25)* | 15 | — | — | 0.85 | A (25) | H (13)* | 9 | — | — |
| 10 | 0.62 | — | J (18) | 15 | — | — | 0.35 | A (25) | H (1)** | 1.8 | — | — |
| 11 | 0.71 | — | J (15) | 20 | — | — | 0.71 | C (40) | H (7) | 5 | — | — |
| 12 | 0.65 | A (25) | H (10)** | 3.5 | — | — | 0.50 | A (25) | H (3)** | 5 | — | — |
| 13 | 0.85 | A (25) | H (13) | 9 | — | — | 0.75 | A (25) | H (7) | 5 | — | — |
| 14 | 0.84 | A (30) | H (13)* | 9 | — | — | 0.71 | A (30) | H (14)* | 2 | — | — |
| 15 | 0.85 | A (25) | H (13)** | 9 | — | — | 0.53 | D (40) | H (3) | 5 | — | — |
| 16 | 0.75 | A (30) | I (50) | 12 | — | — | 0.75 | B (30) | I (50) | 12 | — | — |
| 17 | 0.86 | B (25) | H (13)** | 9 | — | — | 0.80 | B (30) | H (10)* | 7 | — | — |
| 18 | 0.65 | C (25) | J (15) | 15 | — | — | 0.68 | C (30) | H (10) | 3.5 | — | — |
| 19 | 0.80 | C (30) | I (50) | 25 | — | — | 0.76 | C (40) | H (8) | 5 | — | — |
| 20 | 0.86 | D (40) | H (13) | 9 | — | — | 0.23 | D (40) | I (10) | 2 | — | — |
| 21 | 0.80 | D (30) | I (50) | 25 | — | — | 0.65 | D (40) | I (40) | 8 | — | — |
| 22 | 0.60 | E (40) | H (9) | 3 | — | — | 0.85 | A (25) | H (13)* | 9 | — | — |

Note:
Kind of heat releasing additives: H = carbon black, I = titanium oxide, J = Al flake
Kind of magnetic powder: A = [symbol] based soft magnetic ferrite, B = [symbol] -based soft ferrite, C = permalloy (78% Ni), D = permalloy (45% Ni), E = Sendust
Kind of pigment: X = pearlescent pigment, Y = titanium oxide, A = Al flake
*/**contains 30 mass %/25 mass % of Ni as electrical conductivity additives.

TABLE 4

| | Emissivity | | | | R value | Heat releasingproperty | | Self-cooling property | | | |
|---|---|---|---|---|---|---|---|---|---|---|---|
| | Surface | Rearface | | Q value | (a − 0.05) × | ΔT1 | Relative | ΔT2 | Relative | Electrical conductivity | |
| No. | a | b | a × b | 0.9a − b | (b − 0.05) | ° C. | evaluation | ° C. | evaluation | Surface | Rearface |
| 1 | 0.70 | 0.63 | 0.44 | 0.00 | 0.38 | 2.7 | ● | — | — | ⊚ | ⊚ |
| 2 | 0.72 | 0.83 | 0.60 | 0.18 | 0.52 | 3.5 | ⊚ | — | — | ⊚ | ⊚ |
| 3 | 0.86 | 0.80 | 0.69 | −0.03 | 0.61 | 3.5 | ⊚ | — | — | X | X |
| 4 | 0.87 | 0.35 | 0.30 | 0.43 | 0.25 | 2.0 | ◯ | 2.3 | ⊚ | X | ⊚ |
| 5 | 0.65 | 0.82 | 0.53 | −0.24 | 0.46 | 3.3 | ● | — | — | ⊚ | ⊚ |
| 6 | 0.70 | 0.38 | 0.27 | 0.25 | 0.21 | 1.8 | ◯ | 1.9 | ⊚ | X | ⊚ |
| 7 | 0.84 | 0.55 | 0.46 | 0.21 | 0.40 | 2.8 | ● | 1.5 | ⊚ | X | X |
| 8 | 0.85 | 0.53 | 0.45 | 0.24 | 0.38 | 2.7 | ● | 1.6 | ⊚ | X | ⊚ |
| 9 | 0.52 | 0.85 | 0.44 | −0.38 | 0.38 | 2.7 | ● | — | — | ⊚ | ⊚ |
| 10 | 0.62 | 0.35 | 0.22 | 0.21 | 0.17 | 2.2 | ◯ | 1.6 | ⊚ | X | ⊚ |
| 11 | 0.71 | 0.71 | 0.50 | −0.07 | 0.44 | 3.1 | ● | — | — | X | ⊚ |
| 12 | 0.65 | 0.50 | 0.33 | 0.09 | 0.27 | 2.0 | ◯ | 0.7 | ⊚ | ⊚ | ⊚ |
| 13 | 0.85 | 0.75 | 0.64 | 0.02 | 0.56 | 3.7 | ⊚ | — | — | X | X |
| 14 | 0.84 | 0.71 | 0.60 | 0.05 | 0.52 | 3.5 | ⊚ | 0.6 | ◯ | ⊚ | ⊚ |
| 15 | 0.85 | 0.53 | 0.45 | 0.24 | 0.38 | 2.7 | ● | 1.6 | ⊚ | ⊚ | ⊚ |
| 16 | 0.75 | 0.75 | 0.56 | −0.08 | 0.49 | 3.3 | ● | — | — | X | X |
| 17 | 0.86 | 0.80 | 0.69 | −0.03 | 0.61 | 3.5 | ⊚ | — | — | ⊚ | ⊚ |
| 18 | 0.65 | 0.68 | 0.44 | −0.10 | 0.38 | 2.7 | ● | — | — | X | ⊚ |
| 19 | 0.80 | 0.76 | 0.61 | −0.04 | 0.53 | 3.5 | ⊚ | — | — | X | ⊚ |
| 20 | 0.86 | 0.23 | 0.20 | 0.54 | 0.15 | 1.7 | ◯ | 2.5 | ⊚ | ⊚ | ⊚ |
| 21 | 0.80 | 0.65 | 0.52 | 0.07 | 0.45 | 3.1 | ● | 0.7 | ◯ | X | ⊚ |
| 22 | 0.60 | 0.85 | 0.51 | −0.31 | 0.44 | 3.2 | ● | — | — | ⊚ | ⊚ |

From the tables, it can be considered as below.

Among Nos. 1 to 22 in Table 3, Nos. 1 to 11 are examples in which a magnetic coating film is formed only at the rearface, and Nos. 12 to 22 are examples in which the magnetic coating film is formed at the surface and the rearface. In each of the, heat releasing additives are added in the magnetic coating film. Further, Ni is added optionally to the surface/rearface.

As shown in Table 4, since the addition amount of the magnetic powder and the heat releasing additives satisfy the range of the invention, they are excellent in the microwave absorbability (not shown in Table 4) and the heat releasing property and those with those further addition of Ni are excellent also in the electrical conductivity.

Further, in those numbers described above, No. 4, 6 to 8, 1, 12, 14 to 15, 20 to 21 capable of satisfying Q value≧0.045 and R value≧0.08, and the factors for the self-cooling property are further excellent also in the self-cooling property.

However, since Nos. 1, 4, 10, 14, 20 is out of the range of the invention with respect to the thickness of the magnetic coating film, they involve a problem in bending workability, film adhesion and corrosion resistance (none of them is shown in Table 4).

### Example 3

### Study on Microwave Absorbability, Heat Releasing Property, Scratch Resistance and Fingerprint Resistance(3)

In this example, the microwave absorbability, workability, heat releasing property, self-cooling property, electrical conductivity, scratch resistance and fingerprint resistance were examined when a resin film containing various magnetic powders (A, C, E in Example 2) and heat releasing additives (H in Example 2) and, optionally, a electrically conductive additive (Ni in Example 2); and a resin film containing pearlescent pigment (Iriodin 111WII, manufactured by Merck Japan, average particle size of 15 μm or less) as a luster pigment shown in Table 5 and optionally, a electrically conductive additive (Ni in Example 2) was formed to the rearface and both faces of the metal sheet. In this case, the microwave absorbability was evaluated for rearface so as to the correspond to state actually applied to the electronic equipment.

Specifically, eclectically galvanized steel sheet (sheet thickness: 0.8 mm, Zn deposition amount at each of surface and rearface: 20g/m²) was used as the blank steel sheet, a magnetic coating film (base resin: epoxy modified polyester, crosslinker: isocyanate) with addition of various additives shown in Table 5 (magnetic powder, and carbon black, and optionally, Ni) was formed to one surface (surface) or both surfaces (surface and rearface) and then a resin film (base resin: using polyester resin and using melamine resin as a crosslinker) with addition of a luster pigment shown in Table 5 was formed (120×150 mm).

For each of the obtained coated metal sheets described above, the microwave absorbability, workability, electrical conductivity, integrated emissivity for infrared rays at surface/rearface heat releasing property, heat releasing characteristics (ΔT1), and self-cooling property, (ΔT2) were evaluated in the same manner as in Example 3, as well as the scratch resistance and the fingerprint resistance were evaluated according to the following methods.

[Scratch Resistance]

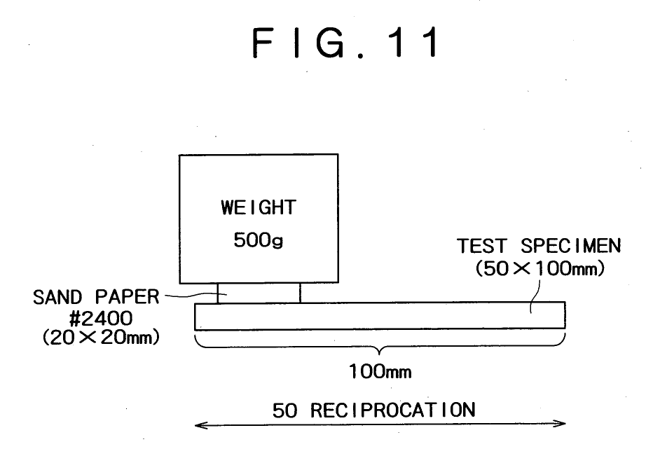

FIG. 11 shows a schematic view for a scratch resistance test conducted in this example. At first, the specimen was cut into 50×100 mm size and, with an aim of examining the scratch resistance test for the surface (on the side applied with a resin coating film), sand paper (#2400, 20×20 mm) was caused to move slidably under the application of 500 g of a weight (cylindrical column of 50 mm diameter) along the longitudinal direction of the specimen (100 mm) for 50 reciprocation cycles in total and then change of appearance in the sliding portion (scratch) was visually evaluated according to the following standard. For the first coated material according to the invention, specimens with ⊚ , ● and ◯ are evaluated as “Example of the invention”.
⊚: scratch scarcely conspicuous ●: scratch slightly conspicuous ◯: scratch somewhat conspicuous
×: scratch conspicuous

In the test method described above, the scratch resistance was evaluated under more severe conditions compared with the scratch resistance test conducted in JP-A No. 2000-200990 described above (improved with scratch resistance, etc., by formation of transparent coating film).

[Finger Print Resistance Evaluation]

After fitting vaseline to fingers sufficiently, fingerprints were left to each of the test specimens and the conspicuousness of the fingerprints was visually observed according to the following standards. For the first coated material according to the invention, the specimens with ⊚, ● and ◯ were evaluated as “Example of the invention”.
⊚: fingerprint scarcely conspicuous
●: fingerprint slightly conspicuous
◯: fingerprint somewhat conspicuous
×: fingerprint conspicuous

The results are shown in Table 6. Results for microwave absorbability and workability according to the method A are omitted in Table 6.

TABLE 5

| | Surface | | | | | | Rearface | | | | | |
|---|---|---|---|---|---|---|---|---|---|---|---|---|
| | | Lower layer | | | | | | Lower layer | | | | |
| | | | Kind of | | | | | | Kind of | | | |
| | | Kind of | heat | | Upper layer | | | Kind of | heat | | Upper layer | |
| | | magnetic | releasing | Film | Kind of | Film | | magnetic | releasing | Film | Kind of | Film |
| | Emissivity | powder | additives | thickness | pigment | thickness | Emissivity | powder | additive | thickness | pigment | thickness |
| No. | a | (mass %) | (mass %) | μm | (mass %) | μm | b | (mass %) | (mass %) | μm | (mass %) | μm |
| 1 | 0.86 | — | H (13)* | 9 | X (5)* | 3.2 | 0.65 | B (30) | H (10)* | 3.5 | — | — |
| 2 | 0.84 | — | H (10) | 10 | — | — | 0.84 | C (30) | H (11) | 8 | — | — |
| 3 | 0.76 | — | H (7)* | 6 | X (5)* | 3.2 | 0.65 | D (40) | H (10) | 3 | — | — |
| 4 | 0.80 | — | H (10) | 7 | — | — | 0.76 | E (40) | H (8) | 5 | — | — |
| 5 | 0.79 | A (25) | H (10)** | 7 | X (5)* | 3.2 | 0.69 | A (25) | H (10)* | 3.5 | — | — |
| 6 | 0.65 | C (40) | H (10) | 3 | — | — | 0.77 | C (40) | H (8) | 5 | — | — |
| 7 | 0.86 | C (40) | H (13) | 9 | X (5)* | 3.2 | 0.52 | C (40) | H (3) | 5 | — | — |
| 8 | 0.86 | E (40) | H (13) | 9 | — | — | 0.65 | E (40) | H (10) | 3 | — | — |
| 9 | 0.79 | E (40) | H (10) | 7 | X (5)* | 3.1 | 0.48 | E (40) | I (30) | 4 | — | — |

Note:
Kind of heat releasing additives: H = carbon black, I = titanium oxide Al flake
Kind of magnetic powder: A = [symbol] based soft magnetic ferrite, B = [symbol] -based soft ferrite, C = permalloy (78% Ni), D = permalloy (45% Ni), E = Sendust
Kind of pigment: X = pearlescent pigment, Y = titanium oxide, Z = Al flake
*/**contains 30 mass %/25 mass % of Ni as conductive additives.

TABLE 6

| | | | | | | Heat | | | | | | | | | Micro- |
|---|---|---|---|---|---|---|---|---|---|---|---|---|---|---|---|
| | Emissivity | | | | | releasing- | | Self-cooling | | Electrical | | | Finger- | | wave |
| | Sur- | Rear- | | | R value | property | | property | | conductivity | | Scratch | print | | absorb- |
| | face | face | | Q value | (a − 0.05) × | ΔT1 | Relative | ΔT2 | Relative | Sur- | Rear- | resis- | resis- | L | ability |
| No. | a | b | a × b | 0.9a − b | (b − 0.05) | ° C. | evaluation | ° C. | evaluation | face | face | tance | tance | value | Method B |
| 1 | 0.86 | 0.65 | 0.56 | 0.12 | 0.49 | 3.4 | ● | 1.1 | ◯ | ⊚ | ⊚ | ⊚ | ⊚ | 48.85 | 0.71 |
| 2 | 0.84 | 0.84 | 0.71 | −0.08 | 0.62 | 4.1 | ⊚ | — | — | X | ⊚ | — | — | — | 0.73 |
| 3 | 0.76 | 0.65 | 0.49 | 0.03 | 0.43 | 3.0 | ● | — | — | ⊚ | ⊚ | ⊚ | ⊚ | 50.06 | 0.53 |
| 4 | 0.80 | 0.76 | 0.61 | −0.04 | 0.53 | 3.5 | ⊚ | — | — | X | ⊚ | — | — | — | 0.66 |
| 5 | 0.79 | 0.69 | 0.55 | 0.02 | 0.47 | 3.1 | ● | — | — | ⊚ | ⊚ | ⊚ | ⊚ | 49.55 | 0.64 |
| 6 | 0.65 | 0.77 | 0.50 | −0.19 | 0.43 | 3.1 | ● | — | — | ⊚ | ⊚ | — | — | — | 0.65 |
| 7 | 0.86 | 0.52 | 0.45 | 0.25 | 0.38 | 2.7 | ● | 1.8 | ⊚ | ⊚ | ⊚ | ⊚ | ⊚ | 48.75 | 0.67 |
| 8 | 0.86 | 0.65 | 0.56 | 0.12 | 0.49 | 2.0 | ◯ | 0.7 | ◯ | ⊚ | ⊚ | — | — | — | 0.52 |
| 9 | 0.79 | 0.48 | 0.38 | 0.23 | 0.32 | 3.4 | ● | 1.1 | ◯ | ⊚ | ⊚ | ⊚ | ⊚ | 49.63 | 0.59 |

From the table described above, it can be considered as follows.

Among Nos. 1 to 9 in Table 6, Nos. 1 to 4 are examples in which a black magnetic coating film is formed only to the rearface and Nos. 5 to 9 are examples in which a black magnetic is formed to the surface and the rearface. In each of them, carbon black is added as heat releasing black additives to the magnetic coating film. Further, Ni is added optionally to the surface/rearface.

As shown in Table 6, in each of Nos. 1, 3, 5, 7 and 9, since the factors regarding the magnetic coating film (content of the magnetic powder and the heat releasing additives, and the thickness of the magnetic coating film) and the factors regarding the resin film (content of the luster pigment, film thickness of the resin film and the L value) satisfy the range of the invention, they are excellent in the microwave absorbability and the workability (not shown in Table 5), the heat releasing property, the scratch resistance and the fingerprint resistance and, further, those with addition of Ni are excellent also in the electrical conductivity.

Further, among those numbers described above, Nos. 1 and 7 to 9 capable of satisfying A value≧0.045 and R value≧0.08 are the factor for self-cooling property are also excellent in the self-cooling property.

On the contrary, Nos. 2, 4, 6 and 8 are examples not forming the resin coating film in which the scratch resistance and the fingerprint resistance were deteriorated.

### Example 4

### Study on Microwave Absorbability, Scratch Resistance and Fingerprint Resistance (4)

In this example, microwave absorbability, workability, electrical conductivity, scratch resistance and fingerprint resistance were examined when a magnetic coating film containing various magnetic powders (A, C and D in Example 2) and black additives (carbon black in Example 2) and, optionally, a electrically conductive additive (Ni in Example 2) shown in Table 7, and a resin film containing various white pigment/luster pigment and, optionally, electrically conductive additive (Ni in Example 2) shown in Table 7 were formed to the rearface or both surfaces of the metal sheet.

Superficially, an electrically galvanized steel sheet (sheet thickness: 0.8 mm; Zn deposition amount each surface and rearface: 20 g/m²) was used as the blank steel sheet, a magnetic coating film (base resin: epoxy modified polyester, crosslinker: isocyanate) with addition of various additives (magnetic powder, carbon black and, optionally, Ni) shown in Table 7 was formed to one surface (surface) or both surfaces (surface and rearface) was formed thereon, further, a resin film (base resin: using polyester resin and melamine resin used as crosslinker) was formed further thereon (120×150 mm).

In the table, details for each of the pigments are as shown below.

[White Pigment/Luster Pigment]

X: pearl pigment (Iriodin 111 WII, manufactured by Merck Japan, average particle size of 15 μm or less),
Y: titanium oxide [JR 301 manufactured by TAYCA CORPORATION, average particle size 0.3 μm]
Z: Al flake [LB584, manufactured by SHOWA ALUMINUM POWDER K.K., average particle size: 25 μm]

The microwave absorbability, electrical conductivity, scratch resistance and fingerprint resistance in each of the obtained coated metal sheets were evaluated in the same manner as in Example 3.

Table 7 shows the result. In the table 7, results regarding the microwave absorbability and workability are omitted.

TABLE 7

| | Surface | | | | | | Rearface | | | | | | | | |
|---|---|---|---|---|---|---|---|---|---|---|---|---|---|---|---|
| | Lower layer | | | Upper layer | | | Lower layer | | | Upper layer | | | | | |
| | Kind of | | Film | | Film | Elec- | Kind of | | Film | | Film | Elec- | | Finger- | |
| | magnetic | Amount | thick- | Kind of | thick- | trical | magnetic | Amount | thick- | Kind of | thick- | trical | Scratch | print | |
| | powder | of CB | ness | pigment | ness | conduc- | powder | of CB | ness | pigment | ness | conduc- | resis- | resis- | L |
| | (mass %) | (mass %) | μm | (mass %) | μm | tivity | (mass %) | (mass %) | μm | (mass %) | μm | tivity | tance | tance | value |
| 1 | — | 10 | 5 | X (5) | 3.1 | X | A (25) | — | 8 | — | — | X | ⊚ | ⊚ | 49.52 |
| 2 | — | 5 | 10 | X (5) | 3.1 | X | C (40) | — | 8 | — | — | ⊚ | ⊚ | ⊚ | 49.63 |
| 3 | — | 10 | 5 | X (5) | 3.2 | X | E (25) | — | 5 | — | — | X | ⊚ | ⊚ | 49.77 |
| 4 | — | 10* | 5 | X (5)* | 3.2 | ⊚ | B (30) | 5* | 5 | X (5)* | 3.1 | ⊚ | ⊚ | ⊚ | 49.81 |
| 5 | — | 10 | 8 | X (5) | 1.5 | X | D (40) | — | 10 | — | — | X | ⊚ | ⊚ | 47.12 |
| 6 | — | 10* | 5 | X (5)* | 4.8 | ⊚ | C (30) | 10 | 8 | — | — | ⊚ | ⊚ | ⊚ | 50.84 |
| 7 | — | 10* | 8 | X (3)* | 3.1 | ⊚ | B (30) | * | 8 | — | — | ⊚ | ⊚ | ⊚ | 47.52 |
| 8 | — | 10 | 7 | Y (20) | 3.1 | X | A (30) | * | 7 | — | — | ⊚ | ● | ● | 54.44 |
| 9 | — | 10 | 8 | Z (5) | 3.2 | X | C (40) | 10 | 8 | Z (5) | 3.1 | X | ⊚ | ⊚ | 50.76 |
| 10 | A (25) | 10* | 7 | X (5)* | 3.2 | ⊚ | A (25) | * | 5 | — | — | ⊚ | ⊚ | ⊚ | 49.71 |
| 11 | D (30) | 10 | 5 | X (5)* | 3.1 | ⊚ | D (30) | 10 | 5 | — | — | ⊚ | ⊚ | ⊚ | 49.66 |
| 12 | C (40) | 10 | 8 | Y (10)* | 3.1 | ⊚ | C (40) | 10 | 5 | Y (10)* | 3.1 | ⊚ | ⊚ | ⊚ | 49.49 |
| 13 | A (30) | 10 | 8 | Y (10) | 3.2 | X | E (40) | 10 | 5 | Y (10) | 3.2 | X | ⊚ | ⊚ | 49.33 |
| 14 | C (40) | 5 | 8 | X (10)* | 3.0 | ⊚ | D (40) | 10 | 7 | — | — | ⊚ | ● | ● | 53.80 |

Note:
CB = carbon black,
Kind of magnetic powder: A = [symbol] based soft magnetic ferrite, B = [symbol] -based soft ferrite, C = permalloy (78% Ni), D = permalloy (45% Ni), E = Sendust
Kind of pigment: X = pearlescent pigment, Y = titanium oxide, Z = Al flake
*contains 30 mass % of Ni as electrical conductivity additives

In view of the tables described above, it can be considered as follows.

Among Nos. 1 to 14 in Table 5, Nos. 1 to 9 are examples containing the magnetic powder only at the rearface and Nos. 1 to 14 are examples containing the magnetic powder at the surface, and rearface and a resin film containing white pigment/luster pigment is formed thereover with an aim of examining at least the scratch resistance and the fingerprint resistance at the surface (black coating film). Further, Ni is optionally added to surface/rearface.

As shown in Table 7, in each of Nos. 1 to 14 described above, since the factors regarding the magnetic coating film (content of the magnetic powder and the thickness of the magnetic coating film) and the factors regarding the resin film (content of white pigment/luster pigment, thickness of resin film and L value) satisfy the range of the invention, they are excellent in the microwave absorbability (not shown in Table 7), scratch resistance and fingerprint resistance and, further, those with addition of Ni are also excellent in the electrical conductivity.

1. A resin coated metal sheet in which a magnetic coating film containing a magnetic powder is coated to a thickness from 3 to 50 μm at least on one surface of a metal sheet.

2. The resin coated metal sheet according to claim 1, wherein the magnetic powder is a soft magnetic ferrite powder.

3. The resin coated metal sheet according to claim 2, wherein the magnetic powder is a magnetic metal powder.

4. The resin coated metal sheet according to claim 1, wherein a resin constituting the magnetic coating film is a polyester resin.

5. The resin coated metal sheet according to claim 1, wherein the magnetic coating film further contains from 20 to 40% of an electrically conductive additive and the thickness of the magnetic coating film is from 3 to 15 μm.

6. The resin coated metal sheet according to claim 5, wherein a total content of the electrically conductive additive and the magnetic powder in the magnetic coating film is from 30 to 60%.

7. The resin coated metal sheet according to claim 1, which satisfies the following (1) or (2) and satisfies the following (3):
(1) the magnetic coating film described above which is a heat releasing magnetic film having a heat releasing property is coated on one surface of the metal sheet and a heat releasing coating film of a thickness of 1 μm or more is coated on another surface of the metal sheet,
at least one of the heat releasing magnetic coating film and the heat releasing coating film contains 1% or more of carbon black, and
the coating film not containing carbon black contains 10% or more of heat releasing additives other than carbon black:
(2) the magnetic coating film which is a heat releasing magnetic coating film having a heat releasing property is coated on both surfaces of the metal sheet,
the heat releasing magnetic coating film on at least one surface containing 1% or more of carbon black,
the coating film not containing carbon black contains 10% or more of heat releasing additives other than carbon black:
(3) an integrated emissivity of infrared rays (wavelength: 4.5 to 15.4 μm) when heating the resin coated metal sheet to 100° C. can satisfy the following formula (1):
a×b≧0.42 formula (1)
a: integrated infrared ray emissivity at one surface of the resin coated metal sheet.
b: integrated infrared ray emissivity at another surface of the resin coated metal sheet.

8. The resin coated metal sheet according to claim 7, wherein an average particle size of carbon black is from 5 to 100 nm.

9. The resin coated metal sheet according to claim 1, which can satisfy the following formula (1) or (2) and satisfy the following (3):
(1) the magnetic coating film described above which is a heat releasing magnetic film having a heat releasing property is coated on one surface of the metal sheet and a heat releasing coating film of a thickness of 1 μm or more is coated on another surface of the metal sheet
at least one of the heat releasing magnetic coating film and the heat releasing coating film contains 30% or more of titanium oxide, and
the coating film not containing titanium oxide contains 1% or more of heat releasing additives other than titanium oxide:
(2) the magnetic coating film which is a heat releasing magnetic coating film having a heat releasing property is coated on both surfaces of the metal sheet,
at least one of the heat releasing magnetic coating films contains 30% or more of titanium oxide,
the coating film not containing titanium oxide contains 1% or more of heat releasing additives other than titanium oxide:
(3) an integrated emissivity of infrared rays (wavelength: 4.5 to 15.4 μm) when heating the resin coated metal sheet to 100° C. can satisfy the following formula (1):
a×b≧0.42 formula (1)
a: infrared-ray integrated emissivity at one surface of the resin coated metal sheet.
b: infrared-ray integrated emissivity at another surface of the resin coated metal sheet.

10. The resin coated metal sheet according to claim 1, which can satisfy the following (1) or (2) and satisfy the following (3):
(1) a first surface of the metal sheet is coated with the magnetic coating film and a second surface on a side opposite to the first surface is coated with a heat releasing film of 1 μm or more:
the heat releasing coating film contains 1% or more of heat releasing additives, and
the magnetic coating film selectively further contains 1% or more of heat releasing additives:
(2) both surfaces of the metal sheet are coated each with the magnetic coating film:
the magnetic coating film at the first surface of the metal sheet selectively contains 1% or more of heat releasing additive, and
the magnetic coating film at the second surface on the side opposite to the first surface contains 1% or more of heat releasing additives:
(3) an integrated emissivity of infrared rays (wavelength: 4.5 to 15.4 μm) when heating the resin coated metal sheet to 100° C. can satisfy the following formulae (2) and (3):
b≦0.9(a−0.05) formula (2)
(a−0.05)×(b−0.05)≧0.08 formula (3)
a: integrated infrared ray emissivity at the second surface of the resin coated metal sheet.
b: integrated infrared ray emissivity at the first surface of the resin coated metal sheet.

11. The resin coated metal sheet according to claim 1, which can satisfy the following (1) or (2) and satisfy the following (3) and (4):
(1) one surface of the metal sheet is coated with the magnetic coating film, the magnetic coating film selectively containing black additives, a resin coating film containing at least one of a white pigment and a luster pigment is coated selectively on the magnetic coating film containing the black additives:
another surface of the metal sheet is coated with a black coating film containing black additives and a resin coating film containing at least one of a white pigment and a luster pigment:
(2) both surfaces of the metal sheet are coated each with the magnetic coating film,
the magnetic coating on at least one surface is a black magnetic coating film containing black additives,
a resin coating film comprising at least one of a white pigment and a luster pigment is coated on the black magnetic coating film, and
another surface is selectively coated with a resin coating film containing at least one of a white pigment and a luster pigment:
(3) a thickness of each of the resin coating films is from 0.05 to 10 μm and an addition amount of the white pigment and the luster pigment contained in the resin coating film is from 1 to 25% in total:
(4) a color of a resin coated metal sheet with addition of a white pigment and a luster pigment can satisfy an L value from 44.0 to 60.0 as measured by a color difference meter (SZS-Σ90) manufactured by Nippon Denshoku Industries Co., Ltd.

12. The resin coated metal sheet according to claim 11, wherein at least one of the white pigment and the luster pigment contained in the resin film is an oxide pigment.

13. The resin coated metal sheet according to claim 11, wherein at least one of the white pigment and the luster pigment contains titanium oxide.

14. The resin coated metal sheet according to claim 1, which can satisfy the following (1) or (2) and satisfy the following (3) to (5), wherein
(1) one surface of the metal sheet is coated with the magnetic coating film which is a heat releasing magnetic coating film having a heat releasing property, the heat releasing magnetic coating film selectively contains black additives and, in a case where the heat releasing magnetic coating paint contains the black additives, a resin coating film containing at least one of a white pigment and a luster pigment is further coated selectively,
another surface of the metal sheet is coated with a heat releasing coating film of 1 μm or more and a resin coating film containing at least one of a white pigment and a luster pigment,
at least one of the heat releasing magnetic coating film and the heat releasing coating film contains 1% or more of carbon black, and
a surface not containing carbon black contains 10% or more of heat releasing additives:
(2) both surfaces of the metal sheet are coated with the magnetic coating film which is a heat releasing magnetic coating film having a heat releasing property,
at least one surface of the heat releasing magnetic coating film contains 1% or more of carbon black, and a surface not containing carbon black contains 10% or more of heat releasing additives, and
a resin coating film containing at least one of a white pigment and a luster pigment is coated further over the heat releasing magnetic resin film on at least one surface:
(3) an integrated emissivity of infrared rays (wavelength: 4.5 to 15.4 μm) when heating the resin coated metal sheet to 100° C. can satisfy the following formula (1):
a×b≧0.42 formula (1)
a: integrated infrared ray emissivity at one surface of the resin coated metal sheet.
b: integrated infrared ray emissivity at another surface of the resin coated metal sheet:
(4) a thickness of the resin coating film is from 0.5 to 10 μm, and an addition amount of the white pigment and the luster pigment contained in the resin coating film is from 1 to 25% in total:
(5) a color of a resin coated metal sheet with addition of a white pigment and a luster pigment can satisfy an L value from 44.0 to 60.0 as measured by a color difference meter (SZS-Σ90) manufactured by Nippon Denshoku Industries Co., Ltd.

15. The resin coated metal sheet according to claim 14, wherein an average particle size of the carbon black is from 5 to 100 nm.

16. The resin coated metal sheet according to claim 1, which can satisfy the following (1) or (2) and satisfy the following (3) to (5), wherein
(1) one surface of the metal sheet is coated with the magnetic coating film which is a heat releasing magnetic coating film having a heat releasing property, the heat releasing magnetic coating film selectively contains black additives and, in a case where the heat releasing magnetic coating paint contains the black additives, a resin coating film containing at least one of a white pigment and a luster pigment is further coated selectively,
another surface of the metal sheet is coated with a heat releasing coating film of 1 μm or more and a resin coating film containing at least one of a white pigment and a luster pigment,
at least one of the heat releasing magnetic coating film and the heat releasing coating film contains 30% or more of titanium oxide, and
a surface not containing titanium oxide contains 1% or more of heat releasing additives:
(2) both surfaces of the metal sheet are coated with the magnetic coating film which is a heat releasing magnetic coating film having a heat releasing property,
at least one of the heat releasing magnetic coating films contains 30% or more of titanium oxide, and
a surface not containing titanium oxide contains 1% or more of heat releasing additives, and
a resin coating film containing at least one of a white pigment and a luster pigment is coated further over the heat releasing magnetic resin film on at least one surface:
(3) an integrated emissivity of infrared rays (wavelength: 4.5 to 15.4 μm) when heating the resin coated metal sheet to 100° C. can satisfy the following formula (1):
a×b≧0.42 formula (1)
a: integrated infrared ray emissivity at one surface of the resin coated metal sheet.
b: integrated infrared ray emissivity at another surface of the resin coated metal sheet:
(4) a thickness of each of the resin coating films is from 0.5 to 10 μm, and an addition amount of the white pigment and the luster pigment contained in the resin coating film is from 1 to 25% in total:
(5) a color tone of the resin coated metal sheet with addition of a white pigment and a luster pigment can satisfy an L value from 44.0 to 60.0 as measured by a color difference meter (SZS-Σ90) manufactured by Nippon Denshoku Industries Co., Ltd.

17. The resin coated metal sheet according to claim 1, which can satisfy the following (1) or (2) and satisfy the following (3) to (5):
(1) a first surface of the metal sheet is coated with the magnetic coating film, the magnetic coating film selectively contains black additives and, in a case where the magnetic coating film contains the black additives, a resin coating film containing at least one of a white pigment and a luster pigment is further coated selectively,
the second surface on a side opposite to the first surface is coated with a black heat releasing coating film of 1 μm or more containing 1% or more of black additives, and a resin coating film containing at least one of a white pigment and a luster pigment:
(2) both surfaces of the metal sheets are coated each with the magnetic coating film,
the magnetic coating film at the first surface of the metal sheet selectively contains 1% or more of heat releasing additives,
the magnetic coating film at the second surface on a side opposite to the first surface is a black heat releasing magnetic coating film of 1 μm or more containing 1% or more of black additives, and
at least the black heat releasing coating film of them is coated with a resin coating film containing at least one of a white pigment and a luster pigment:
(3) an integrated emissivity of infrared rays (wavelength: 4.5 to 15.4 μm) when heating the resin coated metal sheet to 100° C. can satisfy the following formulae (2) and (3):
b≦0.9(a−0.05) formula (2)
(a−0.05)×(b−0.05)≧0.08 formula (3)
a: integrated infrared ray emissivity at the second surface of the resin coated metal sheet.
b: integrated infrared ray emissivity at the first surface of the resin coated metal sheet:
(4) a thickness of each of the resin coating film is from 0.5 to 10 μm, and an addition amount of the white pigment and the luster pigment contained in the resin coating film is from 1 to 25% in total:
(5) a color tone of the resin coated metal sheet with addition of a white pigment and a luster pigment can satisfy an L value from 44.0 to 60.0 as measured by a color difference meter (SZS-Σ90) manufactured by Nippon Denshoku Industries Co., Ltd.

18. The resin coated metal sheet according to claim 16, wherein at least one of the white pigment and the luster pigment contained in the resin coating film is an oxide pigment.

19. The resin coated metal sheet according to claim 16, wherein at least one of the white pigment and the luster pigment contains titanium oxide.

20. The resin coated metal sheet according to claim 17, wherein at least one of the white pigment and the luster pigment contained in the resin coating film is an oxide pigment.

21. The resin coated metal sheet according to claim 17, wherein at least one of the white pigment and the luster pigment contains titanium oxide.
